(19) United States
(12) Patent Application Publication
(10) Pub. No.: US 2013/0208808 A1
(43) Pub. Date: Aug. 15, 2013

(54) IMAGE CODING METHOD AND IMAGE DECODING METHOD

(71) Applicant: PANASONIC CORPORATION, (US)

(72) Inventors: Hisao SASAI, Osaka (JP); Takahiro NISHI, Nara (JP); Youji SHIBAHARA, Osaka (JP); Toshiyasu SUGIO, Osaka (JP); Kyoko TANIKAWA, Osaka (JP); Toru MATSUNOBU, Osaka (JP); Kengo TERADA, Osaka (JP)

(73) Assignee: PANASONIC CORPORATION, Osaka (JP)

(21) Appl. No.: 13/761,354

(22) Filed: Feb. 7, 2013

Related U.S. Application Data
(60) Provisional application No. 61/596,466, filed on Feb. 8, 2012.
(60) Provisional application No. 61/611,609, filed on Mar. 16, 2012.
(60) Provisional application No. 61/613,526, filed on Mar. 21, 2012.

(51) Int. Cl. H04N 7/26

(52) U.S. Cl. CPC H04N 19/0089
USPC 375/240.25; 375/240.29

(57) ABSTRACT

An image coding method of coding an image based on a processing unit to generate a bitstream, the method including: filtering a boundary between processing units in a reconstructed image; and storing the filtered reconstructed image in a first memory, wherein, in the filtering, a first filtering process is performed on the boundary between the processing units when the boundary between the processing units is included in a boundary between parallel processing units, the first filtering process being different from a second filtering process which is performed when the boundary between the processing units is not included in the boundary between the parallel processing units.

### CROSS REFERENCE TO RELATED APPLICATIONS

The present application claims the benefit of U.S. Provisional Patent Applications No. 61/596,466 filed on Feb. 8, 2012, No. 61/611,609 filed on Mar. 16, 2012 and No. 61/613,526 filed on Mar. 21, 2012. The entire disclosures of the above-identified applications, including the specifications, drawings and claims are incorporated herein by reference in their entirety.

### FIELD

The present disclosure relates to an image coding method and an image decoding method for parallel operations.

### BACKGROUND

In the conventional image coding methods (for example, see Non-patent Literature 1) represented by the ITU-T standard denoted as H.26× and the ISO/IEC standard denoted as MPEG-x, it is possible to divide a picture corresponding to an image signal into units called slices and code the whole picture on a slice-by-slice basis according to the raster scan order (see FIG. 1) on the whole picture.

The HEVC standard (for example, see Non-patent Literature 2) that has been standardized as a new standard introduces a tile format which makes it possible to divide a picture corresponding to an image signal into tiles having a rectangular shape, and perform a raster scan (see FIG. 2) within each of the tiles resulting from the division. This tile format allows division of the picture in the vertical direction, and thus can reduce memory size requirements for pixel lines.

For example, FIG. 3 shows an example where a picture is divided also in the vertical direction into tiles enclosed by solid lines. The areas enclosed by broken lines are sub-areas further divided as slices from the tiles in the case of a raster scan. FIG. 3 shows a pattern in which each of the tile boundaries does not across any slice boundary, and FIG. 4 shows a pattern in which each of the slice boundaries does not across any tile boundary.

### CITATION LIST

### Non Patent Literature

### [NPL 1]

ISO/IEC 14496-10, “MPEG-4 Part 10 Advanced Video Coding”

### [NPL 2]

Joint Collaborative Team on Video Coding (JCT-VC) of ITU-T SG16 WP3 and ISO/IEC JTC1/SC29/WG11 7th Meeting: Geneva, CH, -21-30 Nov., 2011, JCTVC-G1103, “High Efficiency Video Coding (HEVC) text specification Working Draft 6”, http://phenix.it-sudparis.eu/jct/doc_end_user/documents/7_Genev a/wg11/JCTVC-G1103-v12.zip

### SUMMARY

### Technical Problem

However, the aforementioned conventional method may cause distortion at processing boundaries when areas divided as tiles or slices are processed in parallel. More specifically, when a decoding apparatus is capable of performing parallel processing (parallel decoding) on a current bitstream to be decoded, such areas are coded independently with losses of correlation at the boundaries, and thus distortion called boundary distortion may occur.

In view of this, non-limiting exemplary embodiments provide an image coding method which makes it possible to reduce boundary distortion and an image decoding method which makes it possible to decode a stream having a reduced boundary distortion.

### Solution to Problem

An image coding method according to an aspect of the present disclosure is an image coding method of coding an image based on a processing unit to generate a bitstream, the method including: filtering a boundary between processing units in a reconstructed image; and storing the filtered reconstructed image in a first memory, wherein, in the filtering, a first filtering process is performed on the boundary between the processing units when the boundary between the processing units is included in a boundary between parallel processing units, the first filtering process being different from a second filtering process which is performed when the boundary between the processing units is not included in the boundary between the parallel processing units.

These general and specific aspects may be implemented using a system, an apparatus, an integrated circuit, a computer program, or a computer-readable recording medium such as a CD-ROM, or any combination of systems, apparatuses, integrated circuits, computer programs, or computer-readable recording media.

### Advantageous Effects

The image coding method according to an aspect of the present disclosure makes it possible to reduce coding distortion.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram for illustrating a raster scan.

FIG. 2 is a diagram for illustrating a tile format.

FIG. 3 is a diagram indicating an example of relationships between tiles and slices.

FIG. 4 is a diagram showing an example of relationships between tiles and slices.

FIG. 5 is a block diagram showing an example of a circuit structure of a coding apparatus which performs a conventional coding method.

FIG. 6 is a block diagram showing an example of a structure of a coding apparatus according to Embodiment 1.

FIG. 7 is a block diagram showing an example of a structure of a coding apparatus according to Embodiment 1.

FIG. 8 is a flowchart showing an example of operations by the coding apparatus according to Embodiment 1.

FIG. 9 is a flowchart showing an example of operations by the coding apparatus according to Embodiment 1.

FIG. 10 is a diagram for illustrating a boundary area.

FIG. 11 is a flowchart showing exemplary processes of coding steps.

FIG. 12 is a flowchart showing other exemplary processes of coding steps.

FIG. 13 is a diagram showing examples of header information.

FIG. 14 is a flowchart showing other exemplary processes of coding steps.

FIG. 15 is a flowchart showing other exemplary processes of coding steps.

FIG. 16 is a flowchart showing processes for determining a quantization parameter.

FIG. 17 is a block diagram showing an example of a structure of an image coding apparatus according to Embodiment 1.

FIG. 18 is a block diagram showing an example of a structure of an image decoding apparatus according to Embodiment 1.

FIG. 19 is a diagram showing exemplary videos in a multi-point conference system.

FIG. 20 is a diagram showing other exemplary videos in a multi-point conference system.

FIG. 21A is a diagram showing a boundary between videos in a multi-point conference system.

FIG. 21B is a diagram showing an example of a decoding apparatus which decodes videos in the multi-point conference system.

FIG. 21C is a diagram showing the example of a decoding apparatus which decodes videos in the multi-point conference system.

FIG. 22 is a flowchart showing exemplary operations by a decoding apparatus which decodes videos in a multi-point conference system.

FIG. 23A is a block diagram showing an example of a structure of an image decoding apparatus according to Embodiment 2.

FIG. 23B is a block diagram showing another example of a structure of the image decoding apparatus according to Embodiment 2.

FIG. 24A is a flowchart showing exemplary operations by the decoding apparatus according to Embodiment 2.

FIG. 24B is a flowchart showing exemplary operations by the decoding apparatus according to Embodiment 2.

FIG. 25 is a block diagram showing an example of a structure of the image decoding apparatus according to Embodiment 2.

FIG. 26 is a flowchart related to filter strength determination in a DBF process.

FIG. 27A is a diagram showing an example of a data structure showing filter switch information for a tile boundary in Embodiment 3.

FIG. 27B is a diagram showing an example of a data structure showing filter switch information for a slice boundary in Embodiment 3.

FIG. 27C is a diagram showing an example of data structure showing filter switch information for selecting a line in a column direction and a line in a row direction.

FIG. 28 is a block diagram showing an example of a structure of a coding apparatus according to Embodiment 4.

FIG. 29 is a flowchart showing exemplary filtering processes in Embodiment 4.

FIG. 30 is a block diagram showing a structure of a coding apparatus.

FIG. 31 is a block diagram showing a structure of a decoding apparatus.

FIG. 32A is a diagram for illustrating a tile format.

FIG. 32B is a diagram for illustrating a tile format.

FIG. 33A is a diagram for illustrating a tile format.

FIG. 33B is a diagram for illustrating a tile format.

FIG. 34 is a diagram for illustrating filtering processes in a tile format.

FIG. 35 is a flowchart showing exemplary operations by a coding apparatus and a decoding apparatus.

FIG. 36A is a flowchart showing exemplary operations by the coding apparatus and the decoding apparatus according to Embodiment 5.

FIG. 36B is a flowchart showing exemplary filtering processes for noise reduction in Embodiment 5.

FIG. 37A is a flowchart showing exemplary operations by a coding apparatus and a decoding apparatus according to Embodiment 6.

FIG. 37B is a flowchart showing exemplary operations by a coding apparatus and a decoding apparatus according to Embodiment 6.

FIG. 38 is a flowchart showing an example of how to switch filtering processes in Embodiment 7.

FIG. 39 shows an overall configuration of a content providing system for implementing content distribution services.

FIG. 40 shows an overall configuration of a digital broadcasting system.

FIG. 41 shows a block diagram illustrating an example of a configuration of a television.

FIG. 42 shows a block diagram illustrating an example of a configuration of an information reproducing/recording unit that reads and writes information from and on a recording medium that is an optical disk.

FIG. 43 shows an example of a configuration of a recording medium that is an optical disk.

FIG. 44A shows an example of a cellular phone.

FIG. 44B is a block diagram showing an example of a configuration of a cellular phone.

FIG. 45 illustrates a structure of multiplexed data.

FIG. 46 schematically shows how each stream is multiplexed in multiplexed data.

FIG. 47 shows how a video stream is stored in a stream of PES packets in more detail.

FIG. 48 shows a structure of TS packets and source packets in the multiplexed data.

FIG. 49 shows a data structure of a PMT.

FIG. 50 shows an internal structure of multiplexed data information.

FIG. 51 shows an internal structure of stream attribute information.

FIG. 52 shows steps for identifying video data.

FIG. 53 shows an example of a configuration of an integrated circuit for implementing the moving picture coding method and the moving picture decoding method according to each of embodiments.

FIG. 54 shows a configuration for switching between driving frequencies.

FIG. 55 shows steps for identifying video data and switching between driving frequencies.

FIG. 56 shows an example of a look-up table in which video data standards are associated with driving frequencies.

FIG. 57A is a diagram showing an example of a configuration for sharing a module of a signal processing unit.

FIG. 57B is a diagram showing another example of a configuration for sharing a module of the signal processing unit.

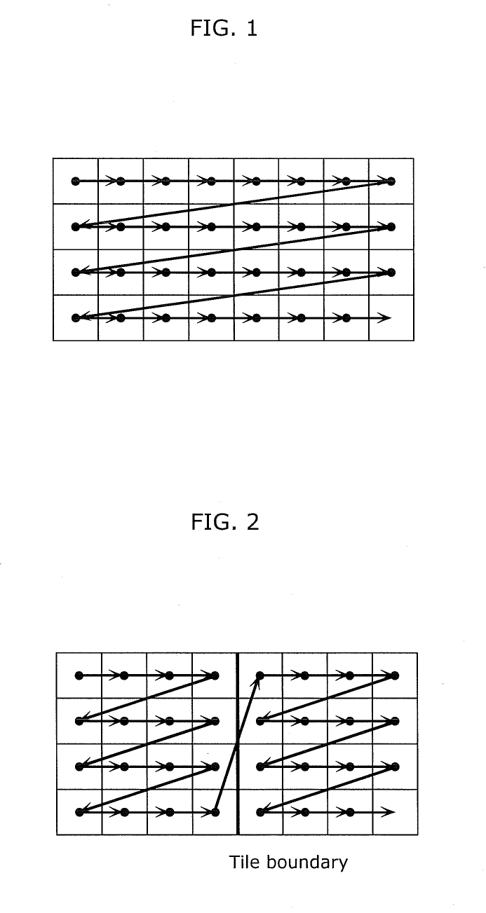

### DESCRIPTION OF EMBODIMENTS

### Outline of the Present Disclosure

An image coding method according to an aspect of the present disclosure is an image coding method of coding an image based on a processing unit to generate a bitstream, the method including: filtering a boundary between processing units in a reconstructed image; and storing the filtered reconstructed image in a first memory, wherein, in the filtering, a first filtering process is performed on the boundary between the processing units when the boundary between the processing units is included in a boundary between parallel processing units, the first filtering process being different from a second filtering process which is performed when the boundary between the processing units is not included in the boundary between the parallel processing units.

For example, the image coding method may further include: determining whether or not a current processing unit has a boundary between parallel processing units; and storing, in a second memory, pixel values which are (i) within the current processing unit and (ii) included in a predetermined range from the boundary between the parallel processing units when the current processing unit has the boundary between the parallel processing units, the current processing unit being reconstructed, wherein, in the filtering, the first filtering process may be performed using the pixel values stored in the second memory when the boundary between the processing units includes the boundary between the parallel processing units.

For example, the image coding method may further include determining a filter strength in the first filtering process, using a representative quantization parameter of at least one of two parallel processing units adjacent to the boundary between the parallel processing units when the boundary between the processing units is included in the boundary between the parallel processing units.

For example, the image coding method may further include adding, to the bitstream, a filter flag indicating whether or not to filter the boundary between the processing units when the boundary between the processing units is included in the boundary between the parallel processing units. In the filtering, it is good to perform the first filtering process on the boundary between the processing units when the filter flag indicates that the boundary between the processing units is to be filtered.

For example, the image coding method may further include adding, to the bitstream, a filter index indicating at least one kind of filtering process among predetermined kinds of filtering processes when the boundary between the processing units is included in the boundary between the parallel processing units, wherein, in the filtering, the at least one kind of filtering process may be performed as the first filtering process when the boundary between the processing units is included in the boundary between the parallel processing units.

For example, in the filtering, it is also good to switch whether or not to perform the first filtering process on the boundary between the processing units depending on whether or not the boundary between the processing units is the boundary in the vertical direction or in the horizontal direction when the boundary between the processing units is included in the boundary between the parallel processing units.

For example, the image coding method may further include: determining whether or not a current processing unit has a boundary between parallel processing units; and quantizing the current processing unit when the current processing unit has the boundary between the parallel processing units, using a quantization parameter smaller than a quantization parameter for use in the case where the current processing unit does not have a boundary between parallel processing units.

For example, the image coding method may further include: adding, to the bitstream, the quantization parameter used in a quantization process on the current processing unit as a representative quantization parameter for parallel processing units to which the current processing unit belongs when the current processing unit has the boundary between the parallel processing units; and determining a filter strength for the first filtering process using the representative quantization parameter when the boundary between the processing units is included in the boundary between the parallel processing units to which the current processing unit belongs.

For example, in the filtering, a filtering process using only pixel value information may be performed as the first filtering process, when the boundary between the processing units is included in the boundary between the parallel processing units.

For example, in the filtering, only a filtering process for reducing block noise may be performed as the first filtering process, when the boundary between the processing units is included in the boundary between the parallel processing units.

For example, in the filtering, a filtering process which is the same in kind as a filtering process for a picture boundary and a filtering process using only pixel value information may be performed as the first filtering process, when the boundary between the processing units is included in the boundary between the parallel processing units.

For example, in the filtering, it is also good to perform, as the first filtering process, the filter process which is the same in kind as the filter process performed on the picture boundary and a filtering process using pixel value information and a quantization parameter, when the boundary between the processing units is included in the boundary between the parallel processing units.

For example, in the filtering, the first filtering process and the second filtering process may be selectively switched and performed on the boundary between the processing units when the boundary between the processing units is included in the boundary between the parallel processing units.

For example, the image coding method may further add, to the bitstream, information related to a switch between the first filtering process and the second filtering process.

An image decoding method according to an aspect of the present disclosure is an image decoding method of decoding an image coded based on a processing unit and included in a bitstream, the method including: filtering a boundary between processing units in a reconstructed image; and storing the filtered reconstructed image in a first memory, wherein, in the filtering, a first filtering process may be performed on the boundary between the processing units when the boundary between the processing units is included in a boundary between parallel processing units, the first filtering process being different from a second filtering process which is performed when the boundary between the processing units is not included in a boundary between parallel processing units.

For example, the image decoding method may further include: determining whether or not a current processing unit has a boundary between parallel processing units; and storing, in a second memory, pixel values which are (i) within the current processing unit and (ii) included in a predetermined range from the boundary between the parallel processing units when the current processing unit has the boundary between the parallel processing units, the current processing unit being reconstructed, wherein, in the filtering, the first filtering process may be performed using some of the pixel values stored in the second memory when the boundary between the processing units includes the boundary between the parallel processing units.

For example, the image decoding method may further include determining a filter strength in the first filtering process, using a representative quantization parameter of at least one of two parallel processing units adjacent to the boundary between the parallel processing units when the boundary between the processing units is included in the boundary between the parallel processing units.

For example, the image decoding method may further include parsing, from the bitstream, a filter flag indicating whether or not to filter the boundary between the processing units when the boundary between the processing units is included in the boundary between the parallel processing units. In the filtering, it is good to perform the first filtering process on the boundary between the processing units when the filter flag indicates that the boundary between the processing units is to be filtered.

For example, the image decoding method may further include parsing, from the bitstream, a filter index indicating at least one kind of filtering process among predetermined kinds of filtering processes, wherein, in the filtering, the at least one kind of filtering process indicated by the filter index may be performed as the first filtering process when the boundary between the processing units is included in the boundary between the parallel processing units.

For example, in the filtering, it is also good to switch whether or not to perform the first filtering process on the boundary between the processing units depending on whether or not the boundary between the processing units is the boundary in the vertical direction or in the horizontal direction when the boundary between the processing units is included in the boundary between the parallel processing units.

For example, image decoding method may further include: determining whether or not a current processing unit has a boundary between parallel processing units; and performing, when the current processing unit has a boundary between parallel processing units, inverse quantization on the current processing unit, using a quantization parameter smaller than a quantization parameter for use in the case where the current processing unit does not have a boundary between parallel processing units.

For example, the image decoding method may further include: parsing, from the bitstream, the quantization parameter used in a quantization process on the current processing unit as a representative quantization parameter for parallel processing units to which the current processing unit belongs when the current processing unit has the boundary between the parallel processing units; and determining a filter strength for the first filtering process using the representative quantization parameter when the boundary between the processing units is included in the boundary between the parallel processing units to which the current processing unit belongs.

For example, in the filtering, a filtering process using only pixel value information may be performed as the first filtering process, when the boundary between the processing units is included in the boundary between the parallel processing units.

For example, in the filtering, only a filtering process for reducing block noise may be performed as the first filtering process, when the boundary between the processing units is included in the boundary between the parallel processing units.

For example, in the filtering, a filtering process which is the same in kind as a filtering process for a picture boundary and a filtering process using only pixel value information may be performed as the first filtering process, when the boundary between the processing units is included in the boundary between the parallel processing units.

For example, in the filtering, it is also good to perform, as the first filtering process, the filter process which is the same as the filter process performed on the picture boundary and a filtering process using pixel value information and a quantization parameter, when the boundary between the processing units is included in the boundary between the parallel processing units.

For example, in the filtering, the first filtering process and the second filtering process may be selectively switched and performed on the boundary between the processing units when the boundary between the processing units is included in the boundary between the parallel processing units.

For example, the image decoding method may further include parsing, from the bitstream, information related to a switch between the first filtering process and the second filtering process. In the filtering, it is also good to switch between the first filtering process and the second filtering process according to the analyzed information related to the switch.

These general and specific aspects may be implemented using a system, an apparatus, an integrated circuit, a computer program, or a computer-readable recording medium such as a CD-ROM, or any combination of systems, apparatuses, integrated circuits, computer programs, or computer-readable recording media.

Hereinafter, embodiments are described in detail with reference to the drawings.

It is to be noted that each of the embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims. Therefore, among the structural elements in the following embodiments, structural elements not recited in any one of the independent claims which define the most generic concept are described as arbitrary structural elements.

### Embodiment 1

Embodiment 1 describes how a decoding apparatus capable of performing parallel decoding performs a method of decoding a bitstream in parallel and removing boundary distortion which occurs when a parallel-decoded image signal is reconstructed.

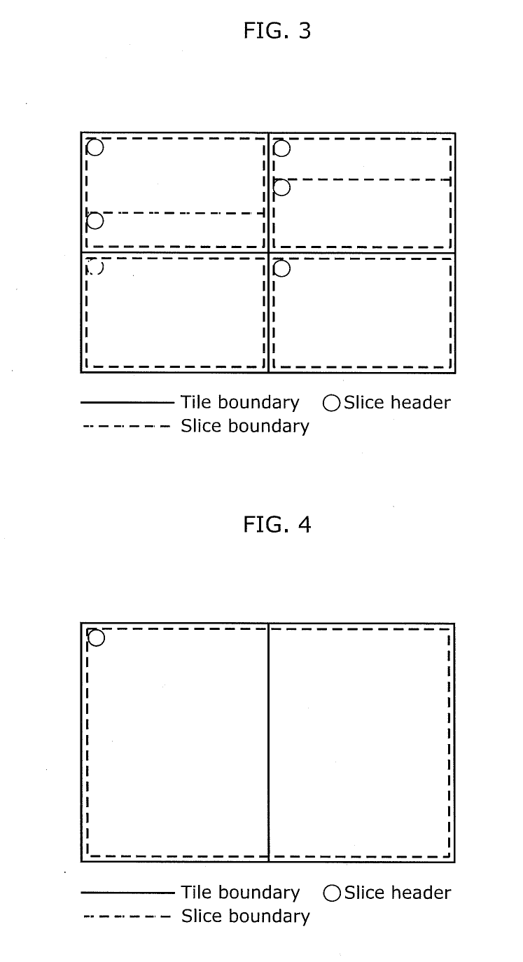

First, a description is given of a case of a structure in which a slice header is always included in the starting point of each of tile boundaries as shown in FIG. 3. Tiles can be obtained by evenly dividing a picture into rectangular shapes. Thus, in an example case of an image which has a short top boundary and is large in the horizontal direction (an image having a resolution called 4K or 8K), it is advantageously possible to reduce the required memory size, it is easy to evenly divide the pixel values into tile areas, and therefore it is possible to perform parallel processing. For this reason, it is important to start such parallel decoding with the starting points of tiles in order to efficiently perform the parallel decoding. In this case, the boundaries that should be the targets from which distortion is removed are slice boundaries.

Next, a description is given of a case of a structure in which a plurality of tiles are included in a slice as shown in FIG. 4. Since tiles can be obtained by evenly dividing a picture into rectangular shapes, in an example case of an image which has a short top boundary and is large in the horizontal direction (an image having a resolution called 4K or 8K), it is advantageously possible to reduce the required memory size, it is easy to evenly divide the pixel values into tile areas, and therefore it is possible to perform parallel processing. In this case, the boundaries that should be the targets from which distortion is removed are tile boundaries.

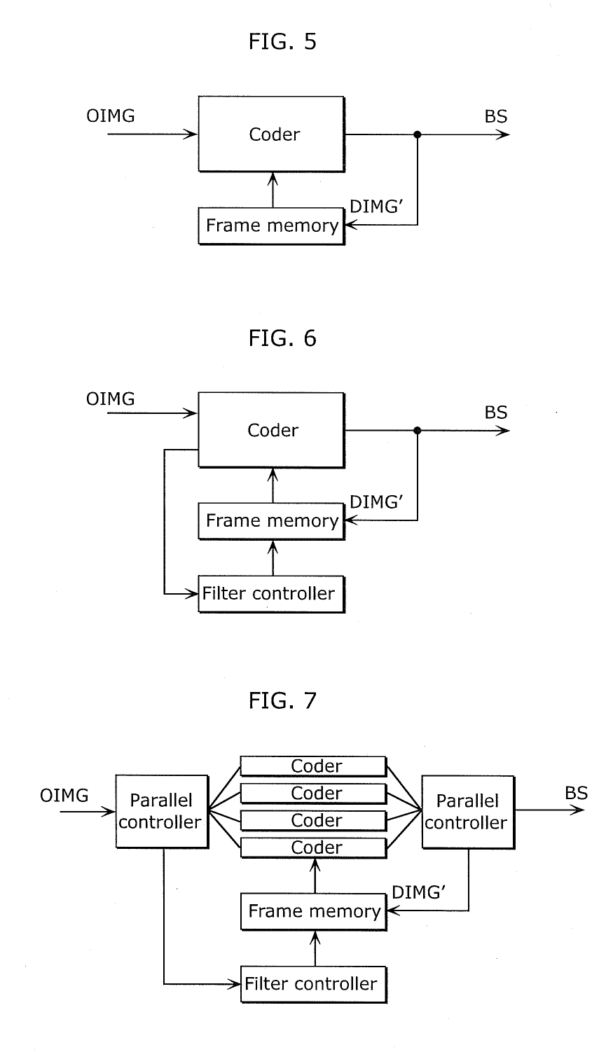

FIG. 5 is a block diagram showing an example of a circuit structure of a coding apparatus which performs a conventional coding method. Here, a description is given of a case of allowing boundary distortion removal when the coding apparatus for generating a bitstream in which parallel processing can be performed does not perform such parallel processing. An input image is coded, a locally decoded image is stored in a frame memory, prediction etc. is performed using an image signal in the frame memory, and then an image of a next target signal is coded.

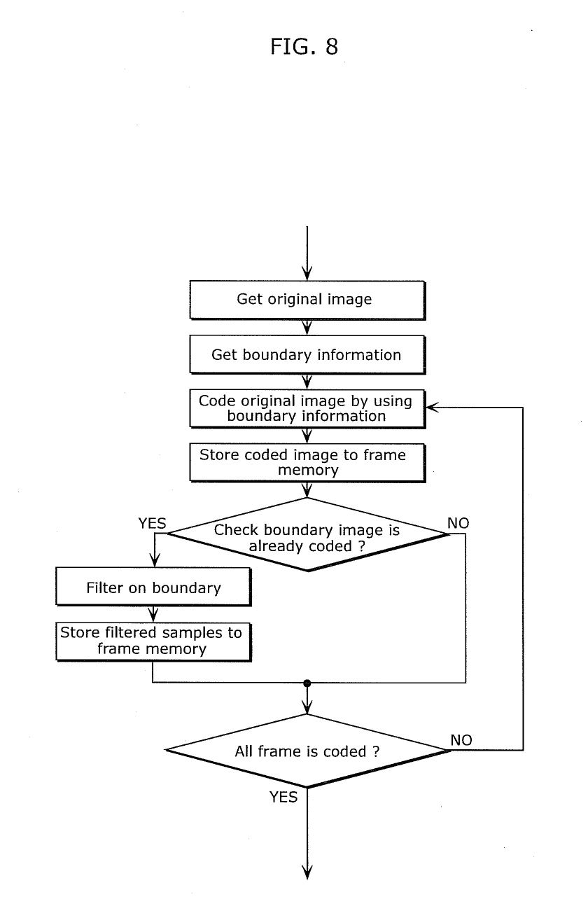

FIG. 6 is a block diagram showing an example of a circuit structure of a coding apparatus which realizes a coding method including a method of removing distortion at processing boundaries according to Embodiment 1. A flow of operations by this coding apparatus is described with reference to FIG. 8. The coding apparatus obtains an input image (original image), and obtains information (boundary information) related to target processing boundaries. The coding apparatus codes the input image using information related to the processing boundaries (processing units). More specifically, the coding apparatus independently codes each of the processing units. Next, decoded images of coded pixel areas are stored onto a frame memory.

Here, whether a current decoded image is located at any boundary area or not is determined. In short, whether the current decoded image is a boundary image or not is determined. Here, coordinate information used in coding may be used for this determination. In addition, a boundary image may be an image including a predetermined range (a boundary area) defined by, for example, a unit of 1 pixel, 2 pixels, or 4 pixels from a processing boundary. Here, this range (boundary area) may be defined using information that is recorded on a part called a sequence parameter set, or may be defined using information that is recorded on other header information. It is only necessary that the definition of the boundary area is the same between the encoder side and the decoder side.

Here, when a current decoded image is a boundary image and is already processed, filtering is performed on the boundary. This filtering is described in detail later. In addition, filtered image signals are stored in the frame memory.

On the other hand, when a current decoded image is not a boundary image, encoding is executed until all coding processes are completed. When all the coding processes are completed, the coding is completed.

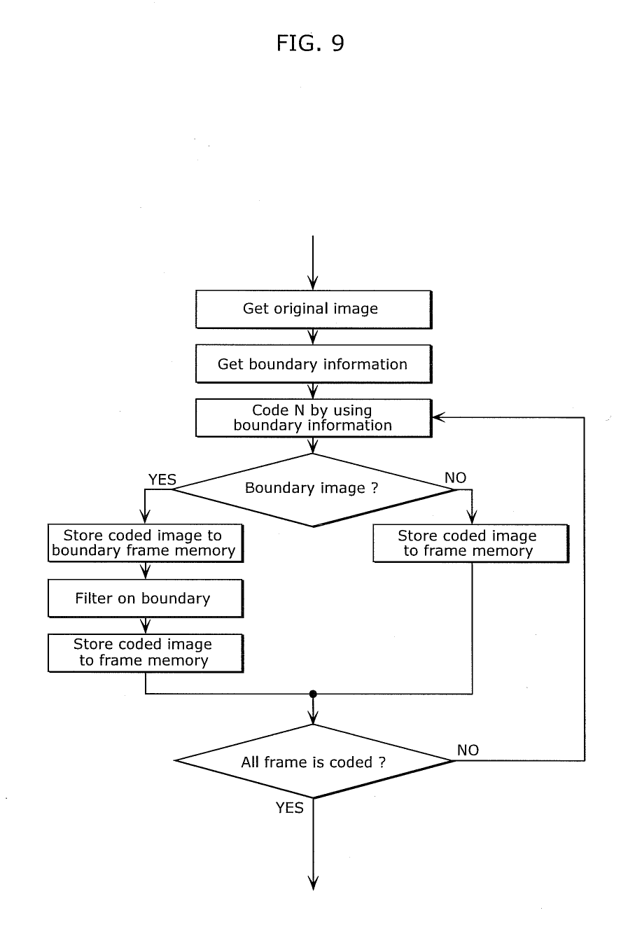

FIG. 7 is a block diagram showing another example of a circuit structure of a coding apparatus which realizes a coding method including a method of removing distortion at processing boundaries. Here, a description is given of a case where four parallel encoders execute parallel processing. A flow of operations by this coding apparatus is described with reference to FIG. 9.

The coding apparatus obtains an input image (original image), and obtains information (boundary information) related to target processing boundaries. The coding apparatus assigns the input image to the parallel encoders using information related to processing boundaries (processing units). More specifically, the coding apparatus divides the input image into processing units in order to independently encode the processing units.

Next, whether a current decoded image is located at any boundary area or not is determined. In short, whether the current decoded image is a boundary image or not is determined. Here, coordinate information used in coding may be used for this determination. In addition, a boundary image may be an image including a predetermined range (a boundary area defined by, for example, a unit of 1 pixel, 2 pixels, or 4 pixels from a boundary to be processed. Here, this range (boundary area) may be defined using information that is recorded on a part called a sequence parameter set, or may be defined using information that is recorded on other header information. It is only necessary that the definition of the boundary area is the same between the encoder side and the decoder side.

Here, when a current decoded image is a boundary image, target pixels are stored in a frame memory for boundaries. The filtering process on the boundary is executed on boundaries at the stage that pixels necessary for the filtering process are stored in the frame memory. This filtering process is described in detail later. In addition, the filtered pixels are stored in the frame memory for other coded and decoded images. Here, this process may be performed later.

On the other hand, when a current decoded image is not a boundary image, coded and decoded images are stored in the frame memory.

When a current decoded image is not a boundary image, encoding is executed until all the coding processes are completed. When all the coding processes are completed, the coding is completed.

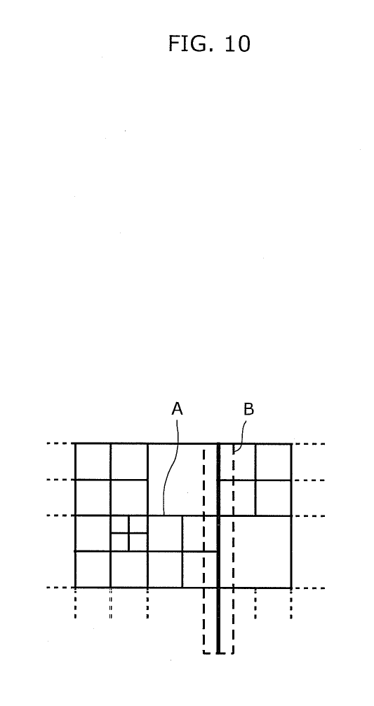

In this way, only boundary areas are subjected to filtering independent of processes in coding, and stored in the frame memory to be used for next coding. Thus, it is possible to use the information for prediction of a next frame, and to increase the coding efficiency by using an image signal with a reduced distortion. FIG. 10 is an illustration for explaining boundary areas. The part denoted as A in FIG. 10 is a processing unit on which, in coding, filtering called a conventional block distortion removal filter is applied. For example, the part denoted as B is a boundary targeted by a filter in this embodiment. The image signals at the right and left sides of this boundary are subjected to different parallel processing, and thus are not subjected to such block distortion removal filter for use in coding.

Next, a filter for reducing boundary distortion is described.

For example, Non-patent Literatures 1 and 2 use a quantization parameter when applying a filter used in coding onto such a boundary. In this case, a quantization parameter for a target block needs to be separately stored for the application of the filtering, and filtering needs to be applied with reference to the quantization parameter in the aforementioned processing. Thus, an additional memory is required. In addition, a long term storage is required (for example, in the case of a horizontal line) depending on timings of parallel processing, and a large number of memories may be required.

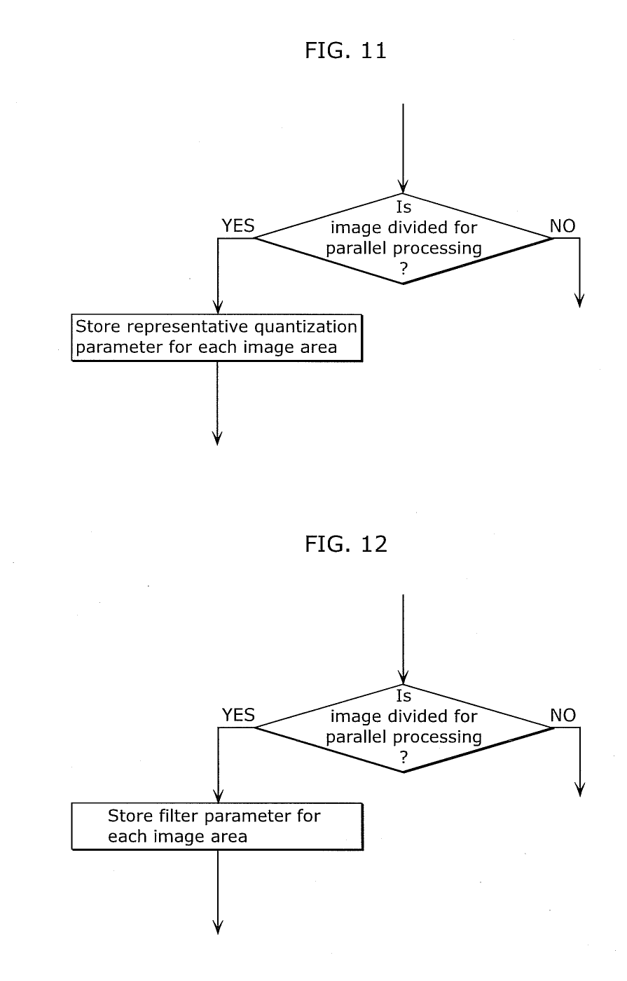

For this reason, in this embodiment, a representative quantization parameter in each processing unit is stored in a header part (a slice header, a tile header, a picture header, or the like) of a bitstream. Thus, it is possible to significantly reduce the memory area for storing quantization parameters for processing blocks at boundaries even when these processing blocks are encoded or decoded in parallel. Here, a flow of processes of coding steps in this case are as shown in FIG. 11.

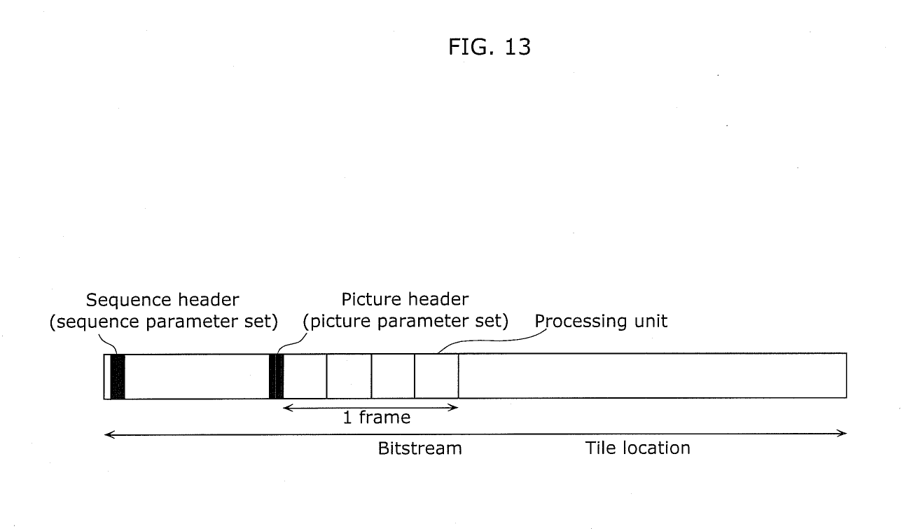

As another method, it is also good to apply a smoothing filter onto such boundaries without applying such a filter used in the processes of coding. Such filters are often used for distortion removal. This embodiment is characterized by applying such filters at parallel boundaries and storing filtered images onto the frame memory. In addition, in this case, it is also good that the coding apparatus and decoding apparatus (i) pre-use a plurality of smoothing filters, or (ii) transmit filter coefficients as supplemental information called SEI, so as to reduce boundary distortion using the filters. Furthermore, it is also good that the coding apparatus and decoding apparatus transmit the plurality of filter coefficients, and transmit indices each indicating which one of the filters is used. In addition, this information may indicate whether or not to apply filtering as ON/OFF. In this way, for example, when there is a fine image around a boundary, it is possible to avoid a loss of image refinement using such a filter. Here, a flow of processes of coding steps in this case is as shown in FIG. 12. In addition, the header information is shown in, for example, FIG. 13.

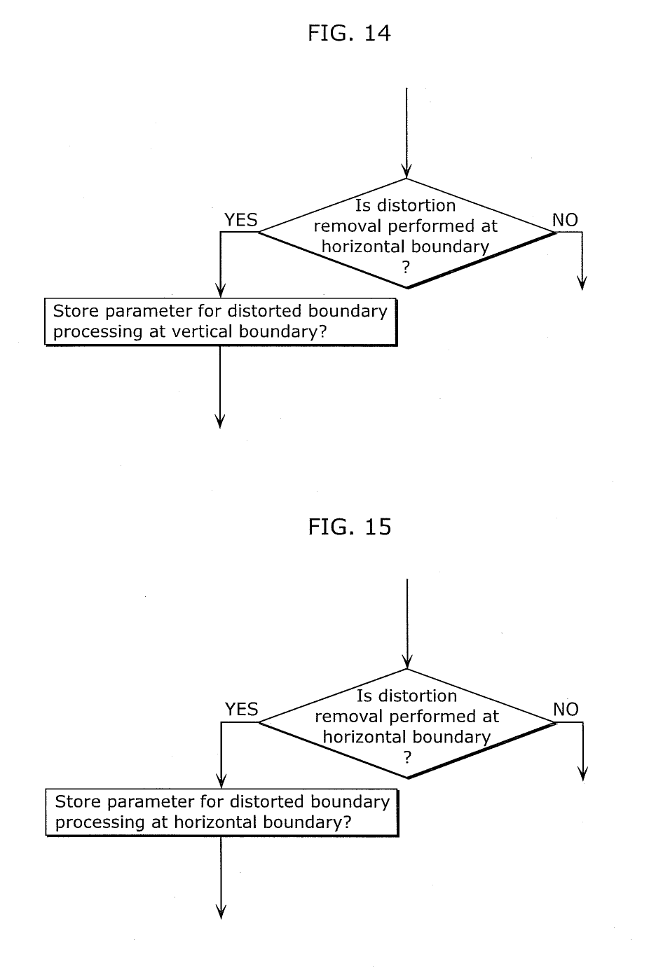

Here, the aforementioned parallel processing boundaries include a vertical boundary and a horizontal boundary. Conventional coding methods rarely produce processing boundaries in the vertical direction. Even some processing boundaries are produced, these boundaries are in the vertical direction in block units. Thus, these boundaries slightly affect the subjective image quality even when a conventional filter for removing block distortion is applied or even if these boundaries remains unfiltered. On the other hand, at processing boundaries called tiles as shown in Non-patent Literature 2, processing boundaries in the vertical direction can appear in the vertical direction continuously between a plurality of blocks. More specifically, since the area within a processing boundary is large, Non-patent Literature 2 has a problem that large distortion occurs in the vertical direction, resulting in significant influence on the subjective image quality. For this reason, it is possible to reduce required information more significantly by dividing processing into processing in the vertical direction and processing in the horizontal direction when performing the aforementioned distortion removal or storing information for the distortion removal. Distortion in the horizontal direction may be noticeable depending on the details of video (for example, distortion in the horizontal direction is noticeable in the case of vertically continuous content (such as woods) as video content). In such a case, distortion removal in the horizontal direction is required. However, if the video is divided in the vertical direction, such division is not noticeable in the video content. In this way, it is possible to determine whether or not to remove distortion depending on the video content, more significant effects can be obtained. Here, a flow of processes in this case is as shown in FIGS. 14 and 15.

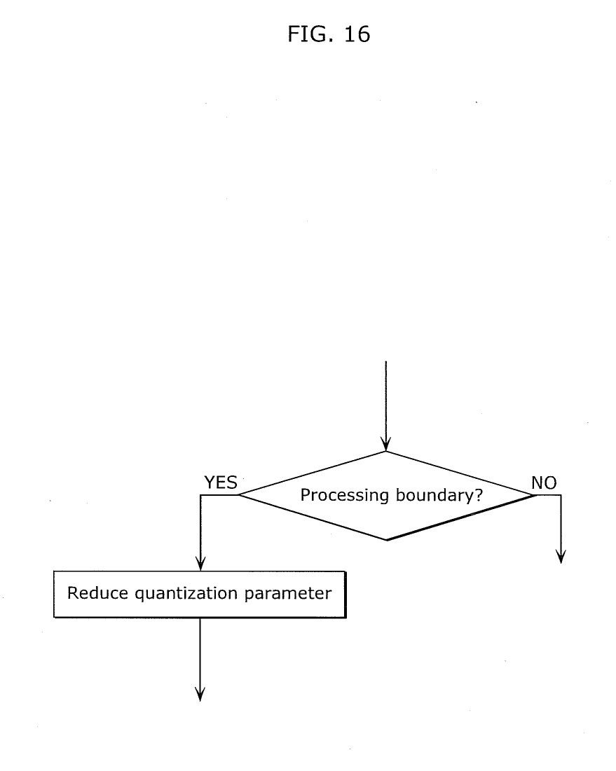

In addition, the aforementioned processing is executed after all the processes, and thus the memory for storing pixel data is required for filtering etc. However, such a memory is not required in the following method. The method is intended to determine whether a current boundary is a processing boundary, and when the current boundary is the processing boundary to reduce a quantization parameter to be used in coding. Since it is possible to reduce coding distortion in this way, it is possible to reduce boundary distortion (FIG. 16). A current boundary is determined to be a processing boundary based on information about processing boundaries to be filtered included in a header when the current boundary is a right end block or a lower end block in the processing and is not at the right end or the lower end of a frame. In addition, when the current block is the left end block or the upper end block and is not at the left end block or upper end block of the frame, the current boundary is determined to be a processing boundary.

In addition, it is also good to reduce the quantization parameter by a previously indicated value (QP_modulation). The QP_modulation is a value indicating a difference from the quantization parameter to be used to encode the block, and is transmitted as the aforementioned header information. In this way, it is possible to reduce information for modifying the quantization parameter according to each processing boundary.

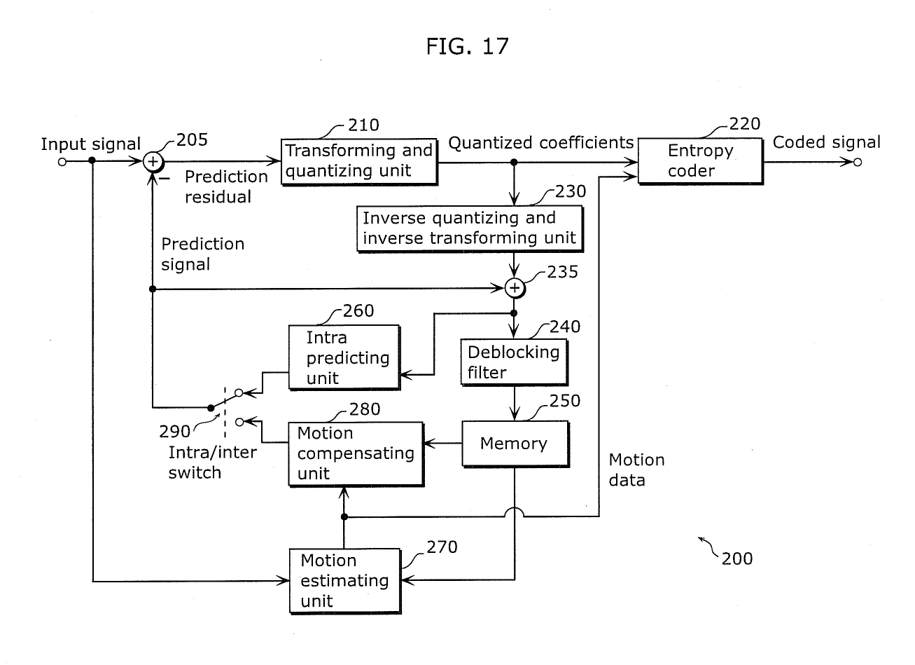

As shown in FIG. 17, the image coding apparatus 200 includes a subtractor 205, a transforming and quantizing unit 210, an entropy encoder 220, an inverse quantizing and inverse transforming unit 230, an adder 235, a deblocking filter 240, a memory 250, an intra predicting unit 260, a motion estimating unit 270, a motion compensating unit 280, and an intra/inter switch 290.

The subtractor 205 calculates a difference between an input signal and a predictive signal, that is, a prediction residual.

The transforming and quantizing unit 210 transforms the prediction residual in a spatial domain to generate transform coefficients in a frequency domain. For example, the transforming and quantizing unit 210 performs Discrete Cosine Transform (DCT) on the prediction residual to generate transform coefficients. Furthermore, the transforming and quantizing unit 210 quantizes the transform coefficients to generate quantized coefficients.

The entropy encoder 220 performs variable length coding on the quantized coefficients to generate a coded signal. In addition, the entropy encoder 220 encodes motion data (for example, a motion vector) estimated by the motion estimating unit 270, and outputs a coded signal including the motion data.

The inverse quantizing and inverse transforming unit 230 performs inverse quantization on the quantized coefficients to reconstruct transform coefficients. Furthermore, the inverse quantizing and inverse transforming unit 230 performs inverse transform on the reconstructed transform coefficients to reconstruct a prediction residual. The reconstructed prediction residual does not have information lost in the quantization, and thus does not match the prediction residual generated by the subtractor 205. In other words, the reconstructed prediction residual includes a quantization error.

The adder 235 adds the reconstructed prediction residual and the prediction signal to generate a locally decoded image.

The deblocking filter 240 performs deblocking filtering on the resulting locally decoded image.

The memory 250 is a memory for storing reference images to be used for motion compensation. More specifically, the memory 250 stores the locally decoded image already subjected to deblocking filtering.

The intra predicting unit 260 performs intra prediction on the predictive signal (intra predictive signal). More specifically, the intra predicting unit 260 performs intra prediction with reference to an image around a current block to be coded (an input signal) in the locally decoded image generated by the adder 235.

The motion estimating unit 270 estimates motion data (for example, a motion vector) between the input signal and a reference image stored in the memory 250.

The motion compensating unit 280 performs motion compensation based on the estimated motion data to generate a prediction signal (an inter predictive signal).

The intra/inter switch 290 selects one of an intra predictive signal and an inter predictive signal, and outputs the selected one as the predictive signal to the subtractor 205 and the adder 235.

With this structure, the image coding apparatus 200 according to this embodiment compression-codes image data.

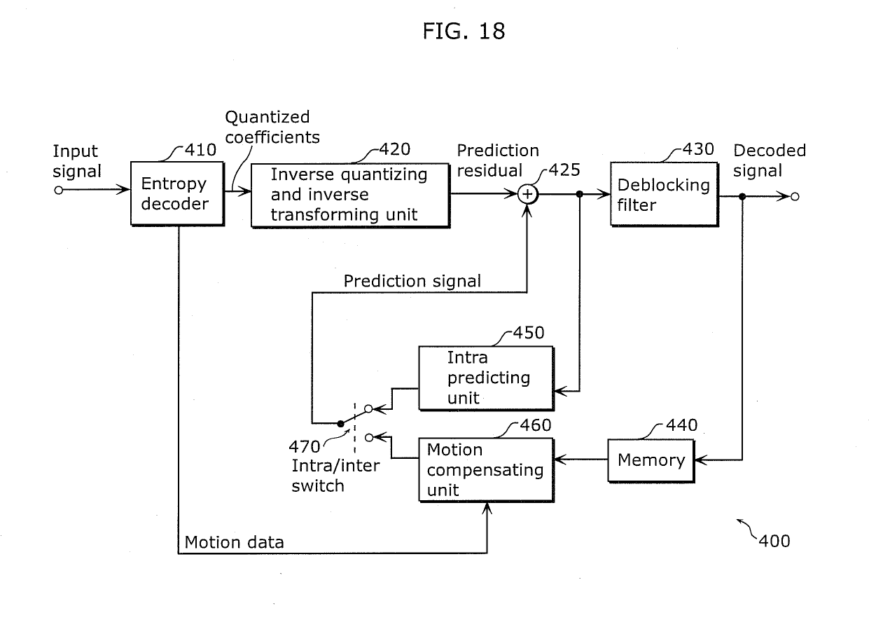

It is to be noted that a parallel decoding determining step according to this embodiment is performed by the image decoding apparatus which decodes compression-coded image data. FIG. 18 is a block diagram showing an example of a structure of an image decoding apparatus 400 according to Embodiment 1.

The image decoding apparatus 400 decodes compression-coded image data. For example, the image decoding apparatus 400 receives, for each block, an input of coded image data as a decoding target signal. The image decoding apparatus 400 performs variable length decoding, inverse quantization, and inverse transform on the input decoding target signal to reconstruct image data.

As shown in FIG. 18, the image decoding apparatus 400 includes an entropy decoder 410, an inverse quantizing and inverse transforming unit 420, an adder 425, a deblocking filter 430, a memory 440, an intra predicting unit 450, a motion compensating unit 460, and an intra/inter switch 470.

The entropy decoder 410 performs variable length decoding on an input signal (input stream) to reconstruct quantized coefficients. Here, the input signal (input stream) is a decoding target signal, and corresponds to data for each block of coded image data. In addition, the entropy decoder 410 obtains motion data from the input signal, and outputs the obtained motion data to the motion compensating unit 460.

The inverse quantizing and inverse transforming unit 420 performs inverse quantization on the quantized coefficients reconstructed by the entropy decoder 410 to reconstruct transform coefficients. Furthermore, the inverse quantizing and inverse transforming unit 420 performs inverse transform on the reconstructed transform coefficients to reconstruct a prediction residual.

The adder 425 adds the reconstructed prediction residual and the prediction signal to generate a decoded image.

The deblocking filter 430 performs deblocking filtering on the resulting decoded image. The deblocking-filtered decoded image is output as a decoded signal.

The memory 440 is a memory for storing reference images to be used for motion compensation. More specifically, the memory 440 stores the deblocking-filtered decoded image.

The intra predicting unit 450 performs intra prediction on the predictive signal (intra predictive signal). More specifically, the intra predicting unit 450 performs intra prediction with reference to an image around a current block to be decoded (input signal) in the decoded image generated by the adder 425.

The motion compensating unit 460 performs motion compensation based on the motion data output by the entropy decoder 410 to generate a prediction signal (inter predictive signal).

The intra/inter switch 470 selects one of an intra predictive signal and an inter predictive signal, and outputs the selected one as the predictive signal to the adder 425.

With the aforementioned structure, the image decoding apparatus 400 according to this embodiment decodes compression-coded image data.

In this way, the image decoding apparatus and the image decoding method according to this embodiment makes it possible to perform correct decoding.

In addition, with this structure, it is possible to suppress decrease in image quality.

As described above, according to this embodiment, the encoder side can encode parallel areas which can be processed in parallel using the schemes predetermined respectively based on information included in headers, applies a filter on each of target boundaries between the parallel areas, stores the images in the frame memory, and uses one of the filtered images to predict a next image. In this way, it is possible to generate a bitstream, allowing for an increased coding efficiency.

In addition, based on the information, it is possible to perform filtering on a boundary between the parallel areas in a decoded image in the decoding of the bitstream, and to thereby reduce boundary distortion in the decoded image.

In this way, this embodiment provides a further increased coding efficiency and thus has a highly practical value.

### Embodiment 2

Embodiment 1 describes how the decoding apparatus capable of performing the parallel decoding performs the method of decoding the bitstream in parallel and removing the boundary distortion which occurs when the image signals processed in parallel are reconstructed. However, when a video is divided in parallel processing units, the boundaries are naturally discontinuous. Therefore, there is no need to perform processing for removing boundary distortion as in Embodiment 1.

For this reason, in Embodiment 2, whether or not to perform the processing for removing boundary distortion is determined depending on an input image and the parallel processing units. Embodiment 2 is described below with reference to the drawings.

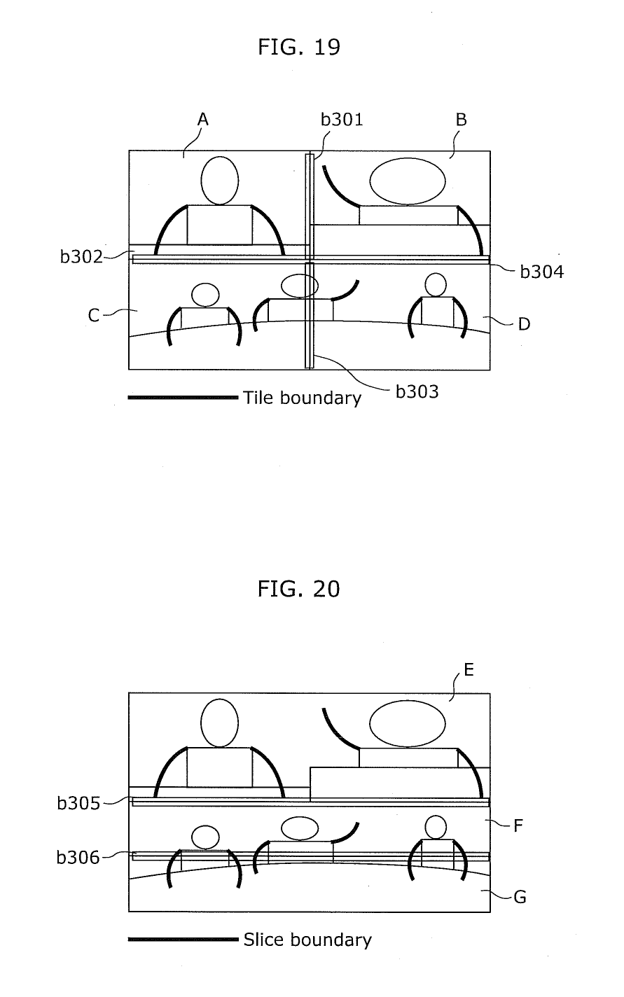

FIG. 19 is an example of a case of videos in, for example, a multi-point conference system. For the purpose of parallel processing, a screen is divided into A, B, C, and D. The boundary between the areas A and B is denoted as b301, the boundary between the areas A and C is denoted as b302, the boundary between the areas C and D is denoted as b303, and the boundary between the areas B and D is denoted as b304.

In addition, in this case, the areas A and B respectively show videos at different locations, and the areas C and D show a video at the same location.

In this exemplary case, the boundary b303 between areas C and D is the only target for the aforementioned distortion removal. This is because the boundaries between the areas A and B, the areas A and C, and the areas B and D divide different videos, and distortion removal on such boundaries dividing different videos may produce strange effects.

As in FIG. 19, FIG. 20 is an example of a case of videos in, for example, a multi-point conference system. In this example, an image is divided into E, F, and G each called a slice. Here, the boundary between the areas E and F is denoted as b305, and the boundary between the areas F and G is denoted as b306.

In addition, in this example, as shown in FIG. 19, the left and right portions of the area E respectively show videos at different locations, and the areas F and G show a video at the same location.

In this exemplary case, the boundary b306 between the areas F and G is the only target for the aforementioned distortion removal. This is because the boundary between the areas E and F divide different videos, and distortion removal on such a boundary dividing different videos may produce strange effects.

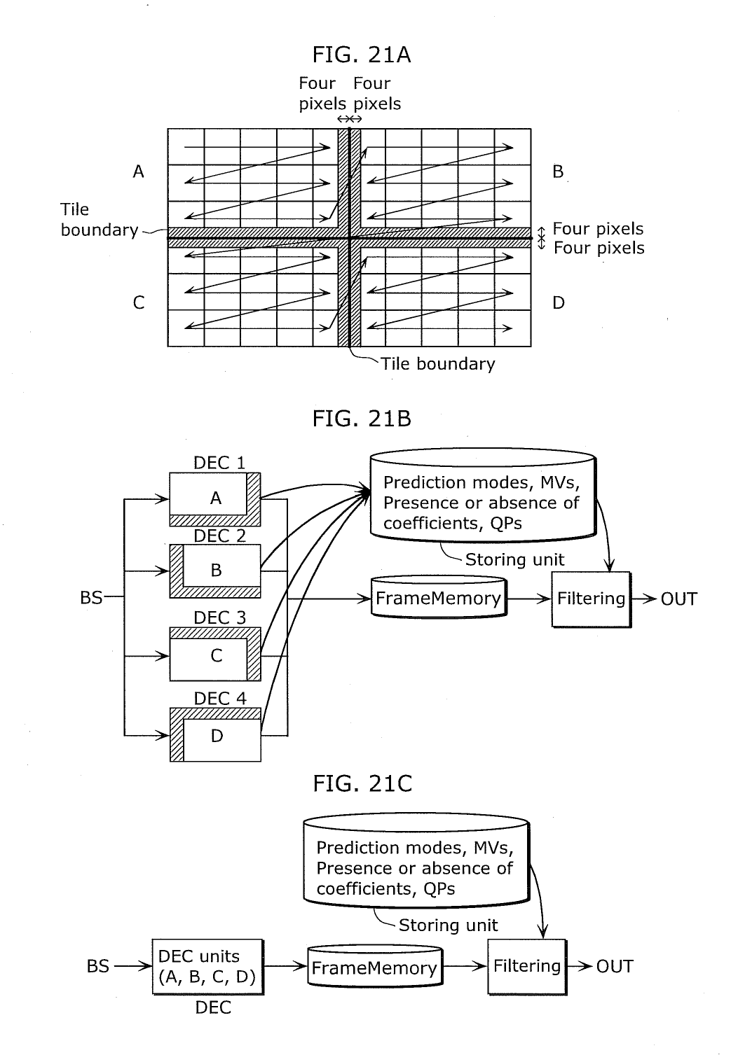

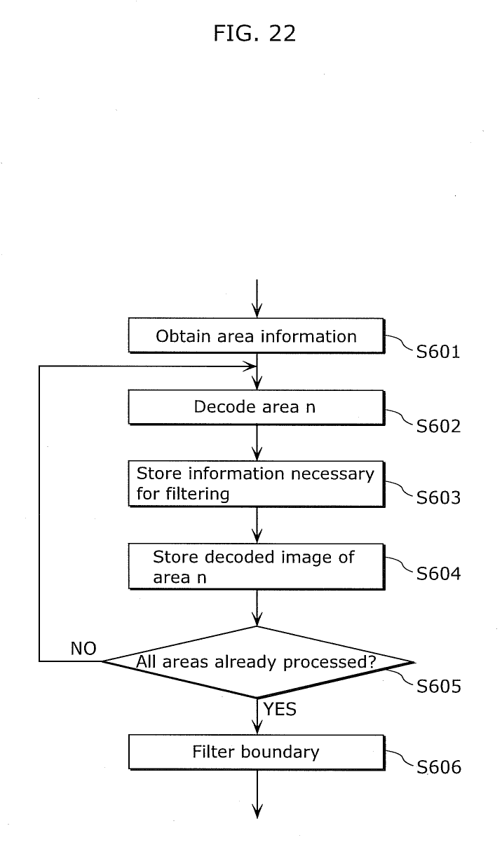

Each of FIGS. 21A to 21C is a schematic diagram for illustrating a decoding method according to Embodiment 1 in the case where the videos in the structure of FIG. 19 are decoded. FIG. 21A is an illustration for explaining in detail the order of processing the areas A, B, C, and D, and the pixels located at the boundary areas. The boundary areas (4 pixels, 4 pixels) shown here is an area on which boundary distortion removal is performed. FIG. 21B is a block diagram showing an example of a structure of the decoding apparatus according to Embodiment 1 in the case where the areas A, B, C, and D are decoded in parallel. This decoding apparatus includes decoders DEC 1, DEC 2, DEC 3, and DEC 4, a frame memory FrameMemory for temporality storing results of decoding, a storing unit for storing information (such as prediction modes, MVs, presence or absence of coefficients, quantization parameters QP) necessary for filtering, and a filtering unit. Operations are described with reference to FIG. 22.

A bitstream BS is obtained, and area information is obtained therefrom (S601). The area n is decoded by a corresponding one of the decoders based on area information (S602), and filtering information related to a corresponding one of hatched areas (a corresponding tile boundary area) is stored in the storing unit (S603). On the other hand, pixel information of the area n is stored in the frame memory for temporary storage (S604). When all the areas are not yet decoded (NO in S605), decoding for the remaining area(s) is continued. On the other hand, when all the areas are already decoded (YES in S605), the filtering unit filters the pixels obtained from the frame memory based on the information obtained from the storing unit (S606), and outputs a decoded image OUT.

Here, the decoders DECs 1 to 4 may be realized as a single DEC processing unit. The structure in this example is FIG. 21C. The results are the same in both the cases. The storing unit and the filtering unit perform the same processing as performed by the equivalent elements in FIG. 21B, and thus no detailed descriptions are repeated.

The decoding apparatus according to Embodiment 1 inevitably filters, for example, the boundary b301 between the areas A and B as shown in FIG. 19, and may produce an unnatural decoded image. For this reason, the decoding method in this Embodiment is different in the point of having a capability of switching between execution and skip of filtering.

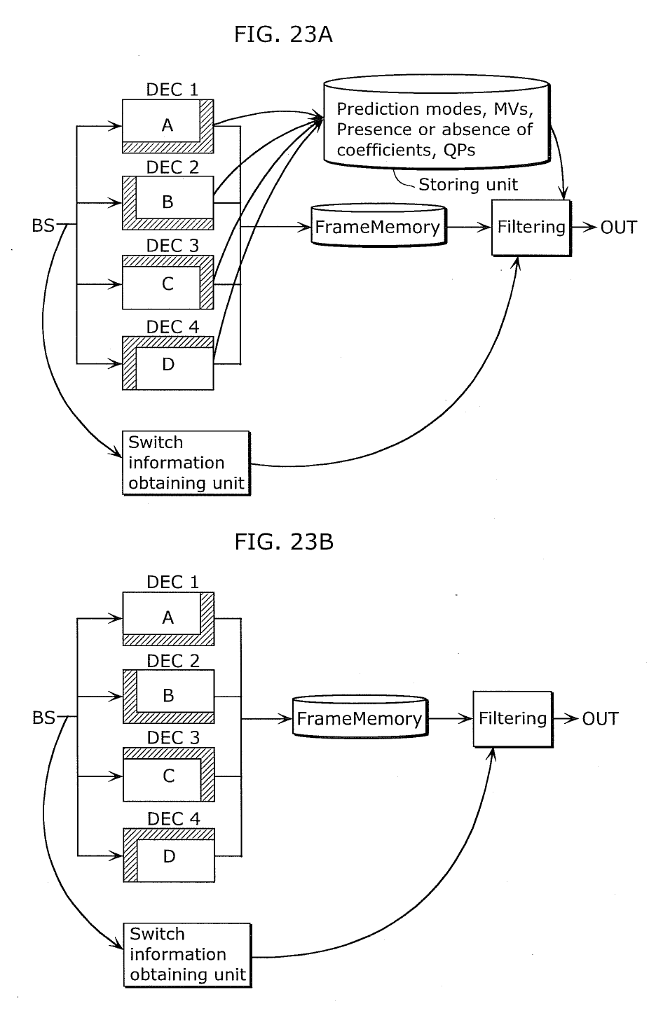

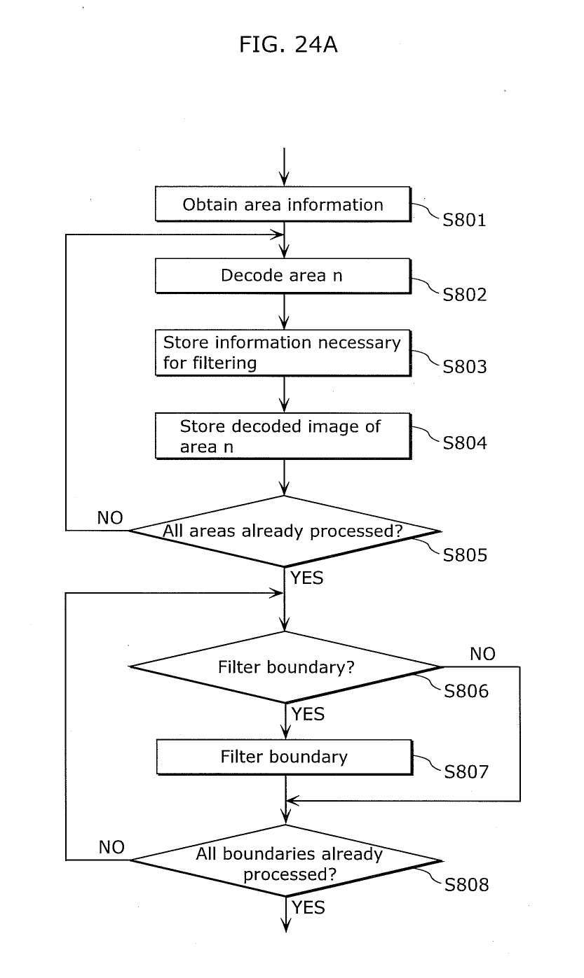

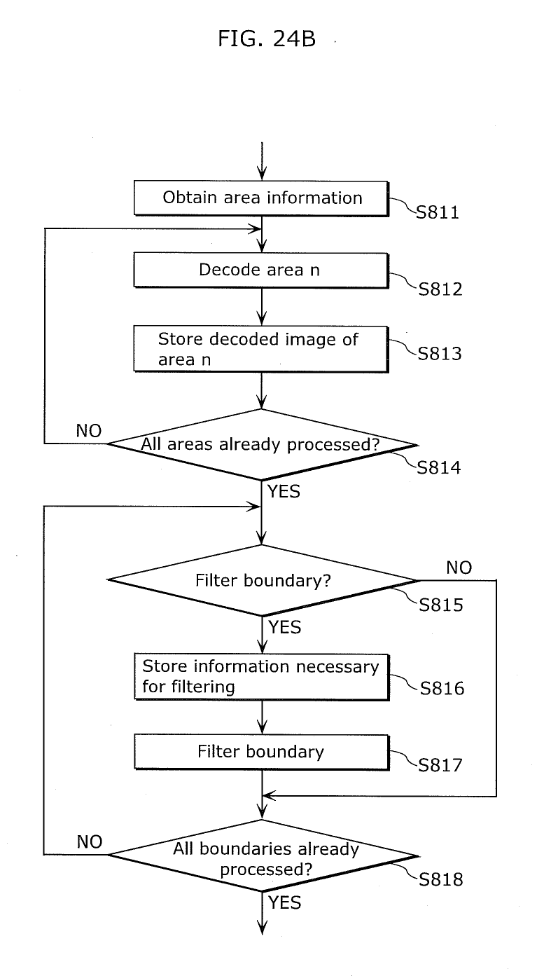

FIG. 23A is a block diagram showing an example of a structure of the decoding apparatus according to Embodiment 2 in the case of decoding in parallel the areas A, B, C, and D in FIG. 21A. This decoding apparatus includes decoders DEC 1, DEC 2, DEC 3, and DEC 4, a frame memory FrameMemory for temporality storing results of decoding, a storing unit for storing information (such as prediction modes, MVs, presence or absence of coefficients, quantization parameters QP) necessary for filtering, a filtering unit, and a switch information obtaining unit. Operations are described with reference to FIG. 24A. A bitstream BS is obtained, and area information is obtained therefrom (S801). The area n is decoded by a corresponding one of the decoders based on area information (S802), filtering information related to a corresponding one of hatched area (a corresponding tile boundary area) is stored in the storing unit (S803). On the other hand, pixel information of the area n is stored in the frame memory for temporary storage (S804). When all the areas are not yet decoded (NO in S805), decoding for the remaining area(s) is continued. On the other hand, when all the areas are already decoded (YES in S805), next, the switch information obtaining unit determines whether or not to apply a filter on the target boundary based on the switch information obtained from the bitstream (S806). When the filter is applied (YES in S806), the filtering unit filters the pixels obtained from the frame memory based on the information obtained from the storing unit (S807). On the other hand, when no boundary filter is applied (NO in S806), no filtering is performed. When all the boundaries are not yet subjected to boundary processing (execution/skip of filtering) (NO in S808), next boundary processing is performed. When all the boundaries are already subjected to boundary processing (YES in S808), a decoded image OUT is output.

In the case of FIG. 19, no filter is applied at the b301, and no filter is applied at the b302. Decoding with application of a filter at the b302 and without application of a filter at the b304 makes it possible to remove boundary distortion without making the video look unnatural. In addition, this is also applicable in the same manner even at slice boundaries. For example, in the case of areas in FIG. 20, it is possible to provide similar effects as in the case of tile boundaries by applying a filter at the b305 and not applying a filter at the b306. The boundary filter is applied at the time when all the areas are decoded in the above-described case, but this case is an example. It is also good to execute next boundary processing after both the side areas of a boundary are decoded. For example, it is good to start the processing of the b301 that is the boundary between the areas A and B after the areas A and B are processed. In this way, it is possible to increase the processing speed.

In order to further reduce the circuit scale, it is good to combine another structure. Such another structure is shown in FIG. 23B. This structure is obtained by excluding the information storing unit that is used for filtering from the decoding apparatus as shown in FIG. 23A. A flow of operations in this structure is described with reference to FIG. 24B.

A bitstream BS is obtained, and area information is obtained therefrom (S811). The area n is decoded by a corresponding one of the decoders based on area information (S812), and pixel information about the area n is stored in the frame memory for temporary storage (S813). When all the areas are not yet decoded (NO in S814), decoding for the remaining area(s) is continued. On the other hand, when all the areas are already decoded (YES in S814), next, the switch information obtaining unit determines whether or not to apply a filter on the target boundary based on the switch information obtained from the bitstream BS (S815). When a filter is applied (YES in S815), information necessary for filtering is stored (S816). The filtering unit filters the pixels obtained from the frame memory, based on the filter information (or predetermined strength information etc.) obtained from the bitstream (S817). On the other hand, when no boundary filter is applied (NO in S815), no filtering is performed. When all the boundaries are not yet subjected to boundary processing (execution/skip of filtering) (NO in S818), next boundary processing is performed. When all the boundaries are already subjected to boundary processing (YES in S818), the decoded image OUT is output.

By employing this structure, it is possible to eliminate the storing unit for storing information about adjacent pixels around boundaries, and to thereby reduce the number of elements of the circuit. In addition, filter switch information (strength switch information) is decoded only when a filter is applied, and thus it is possible to reduce the amount of information necessary for decoding and to apply a filter with consideration of the image quality for each of the boundaries to be subjected to filtering.

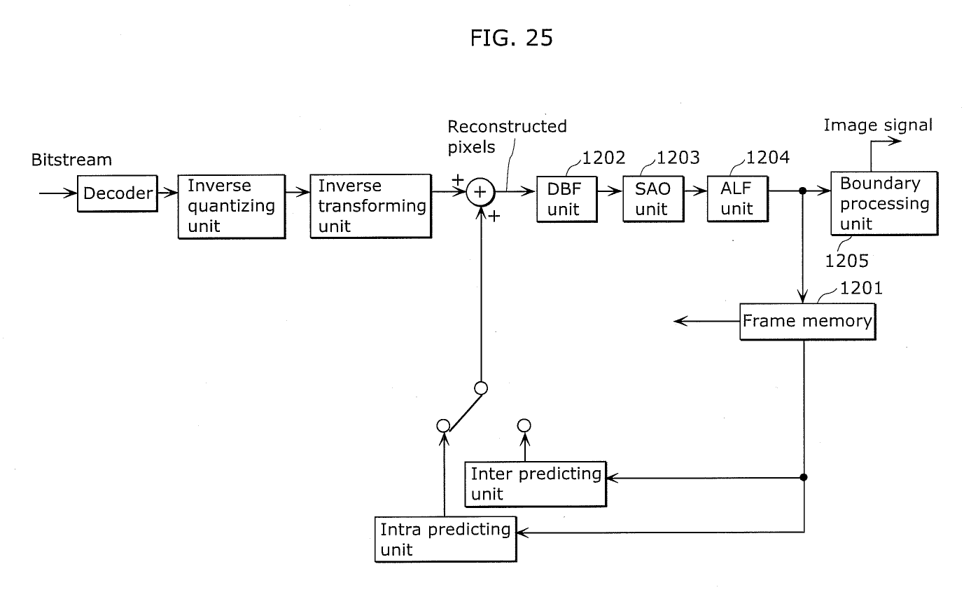

FIG. 25 is a block diagram showing an example of a structure of the image decoding apparatus according to Embodiment 2. More specifically, FIG. 25 is a block diagram showing the structure of the decoding apparatus which is obtained by further adding a boundary processing unit 1205 that is a unique element in this embodiment to a conventional decoding apparatus. An input bitstream is divided into processing units, and the processing units are subjected to decoding, inverse quantization, and inverse transform. Prediction pixel values in each processing unit are calculated by either (i) an intra predicting unit in the case of intra coding with reference to pixels stored in the frame memory 201, specifically, pixels of the picture including a target block or pixels of a picture not including the target block, or (ii) an inter predicting unit in the case of inter coding. The prediction pixel values are added to difference values obtained through inverse transform, resulting in reconstructed pixels. These reconstructed pixels are filtered in the DBF unit 1202, the SAO unit 1203, and the ALF unit 1204, and are then stored in the frame memory 1201 and output. At this time, the Deblocking filter (DBF), the Sample Adaptive Offset (SAO), and the Adaptive Loop Filter (ALF) may not execute their processing.

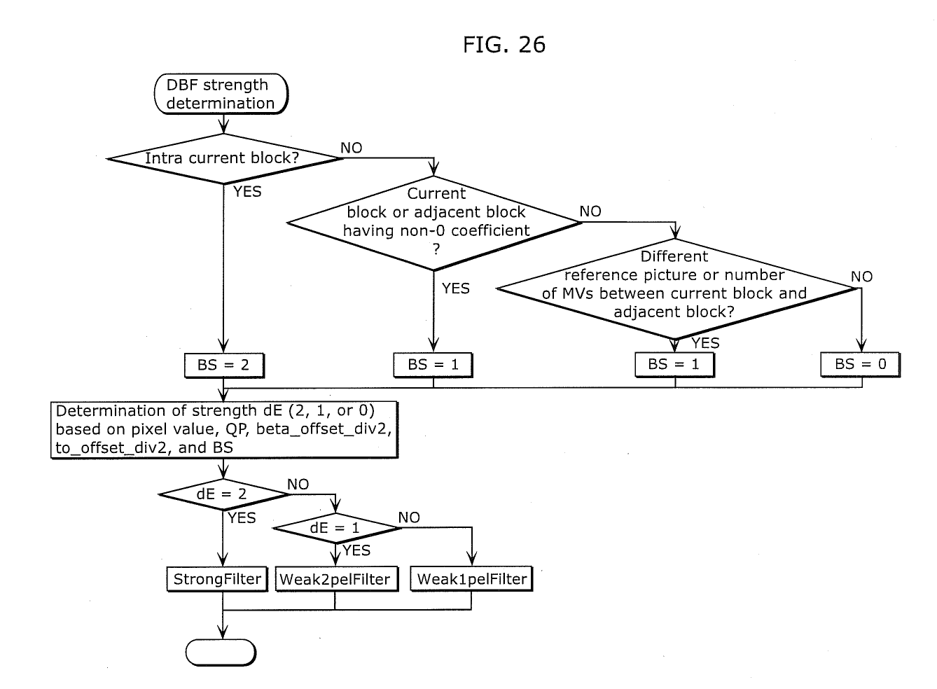

Here, the DBF unit 1202 executes DBF processing defined in the “Deblocking filter process” in section 8.7 of Non-patent Literature 1 or in the “Deblocking filter process” in section 8.7.1 in the HEVC (Non-patent Literature 2). The DBF processing requires not only processing target pixels but also coding modes of blocks to which the pixels belong, motion vectors (MVs), presence or absence of coefficients in quantization, quantization parameters (QPs) etc. as information in filtering, and selects and applies one of filter strengths from three levels of Strong, Weak2pel, and Weak1pel. FIG. 26 shows a filter strength determination flow in DBF processing.

In addition, the SAO unit 1203 executes SAO processing defined in “Sample Adaptive Offset process” in section 8.7.2 in the HEVC (Non-patent Literature 2). In addition, the ALF unit 1204 executes ALF processing defined in the “Adaptive Loop Filter process” in section 8.7.2. The SAO processing does not require information such as coding modes etc. of blocks to which target pixels belong, but requires, as information in filtering, SAO offset information about the positions of the target pixels and the pixels adjacent to the target pixels. The boundary processing unit 1205 in this embodiment rewrites decoded videos in the frame memory 1201. Here, the filter switch information obtained from the bitstream is separately input from the bitstream.

In this way, the image decoding apparatus and image decoding method according to this embodiment make it possible to perform correct decoding.

This structure makes it possible to control filtering suitably for videos, and thus to thereby suppress decrease in the image quality.

### Embodiment 3

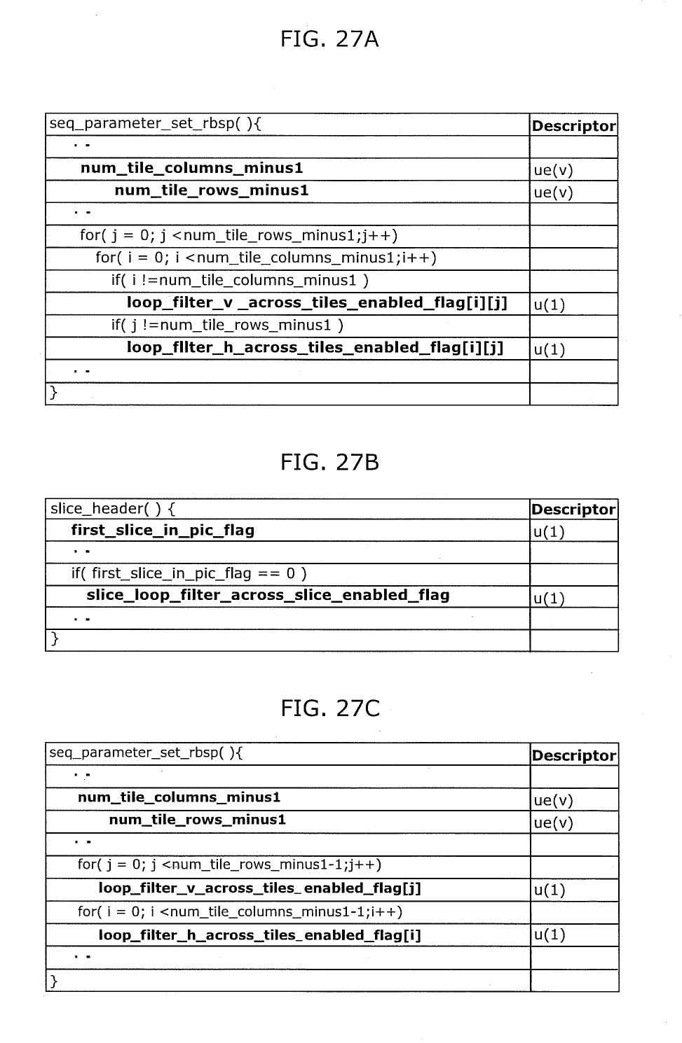

Embodiment 3 describes a data structure of information indicating switching of boundary distortion removal. FIG. 27A is an example of a data structure showing filter switch information for a tile boundary in Embodiment 3. This shows a sequence parameter set that is a part of header information storing information about the whole sequence. Here, num_tile_columns_minus1 is a parameter indicating the number obtained by subtracting 1 from the number of columns of tile shapes, and num_tile_rows_minus1 is a parameter indicating the number obtained by subtracting 1 from the number of rows of the tile shapes. Here, a flag of loop_filter_v_across_tiles_enabled_flag [i] [j], and a flag of loop_filter_h_across_tiles_enabled_flag [i] [j] respectively indicate whether or not a filter should be applied to a current boundary in the vertical direction (right) between current tile shapes and a current boundary in the horizontal direction (bottom) between the current tile shapes.

In addition, by adding an if condition, it is possible to eliminate such flags for the right end and the bottom end of the picture and to skip transmission of redundant information, and to thereby increase the coding efficiency.

Here, the flags each are shown based on the relationship between a column and a row, but these are examples. Tiles are assigned with numbers called tile indices according to the order of processing the shapes resulting through the division. For this reason, it is also good that each of parameters with one-dimensional numbers called tile indices indicates whether or not to apply a filter on a corresponding one of the boundaries adjacent at the right side and bottom side, instead of applying a filter on each of the exemplary parameters having two-dimensional representation using [i] and [j]. In this way, it is possible to compact the parameter representation. In this case, there is no need to transmit any flag in the case where a current tile boundary is also a picture boundary. Thus, by skipping transmission of a flag, it is possible to reduce the amount of codes.

By employing this structure, it is possible to indicate whether or not to apply a filter on each of the tile boundaries.

This filter shape information is not limited to a sequence parameter set. For example, filter shape information may be a picture parameter set that is header information provided in units of a picture.

The filter shape information in this example is handled as flags, but flags are examples. It is also good to code indices including filter strength information instead of the flags.

FIG. 27B is a diagram showing an example of a data structure showing filter switch information for a slice boundary in Embodiment 3. This shows a part of header information called a slice header for storing information about the whole slice. Here, first_slice_in_pic_flag is information indicating whether or not a current slice header information is stored at the top in a picture. The flag indicates 1 in the case where the current slice is stored at the top, and the flag indicates 0 in the other cases. For this reason, a flag slice_loop_filter_across_slices_enabled_flag indicating whether or not to filter a boundary with the immediately previous slice is coded for each of the slices other than the starting slice. For example, the flag indicates 1 when the boundary with the immediately previous slice is to be filtered, and the flag indicates 0 when no filter is applied thereto.

As in the case of FIG. 27A, these flags handled here are examples. It is also good to code indices including filter strength information instead of the flags. By employing this structure, it is possible to switch filters depending on an input image, and to thereby increase the image quality.

Here, in order to reduce the amount of information, it is also good to use only flags loop_filter_v_across_tiles_enabled_flag indicating application of filters to all the boundaries in the vertical direction and loop_filter_h_across_tiles_enabled_flag indicating application of filters to all the boundaries in the horizontal direction instead of using filter switch information for each tile. Even in this case, it is possible to switch filters more effectively than in Embodiment 1, to minimize increase in the amount of information, and to thereby contribute to increase in the image quality.

FIG. 27C shows a data structure which allows selection of a line in the vertical direction and selection of a line in the horizontal direction. This is an exemplary case which is an intermediate case between a case of switching the vertical side and horizontal side of each of the boundaries and a case of indicating whether or not to switch filters for each tile boundary, and in which the image quality and the coding efficiency are balanced. By employing this structure, it is possible to suppress increase in the amount of codes, and to thereby increase the image quality.

### Embodiment 4

Embodiment 4 describes a coding apparatus which generates a bitstream having the aforementioned data structure.

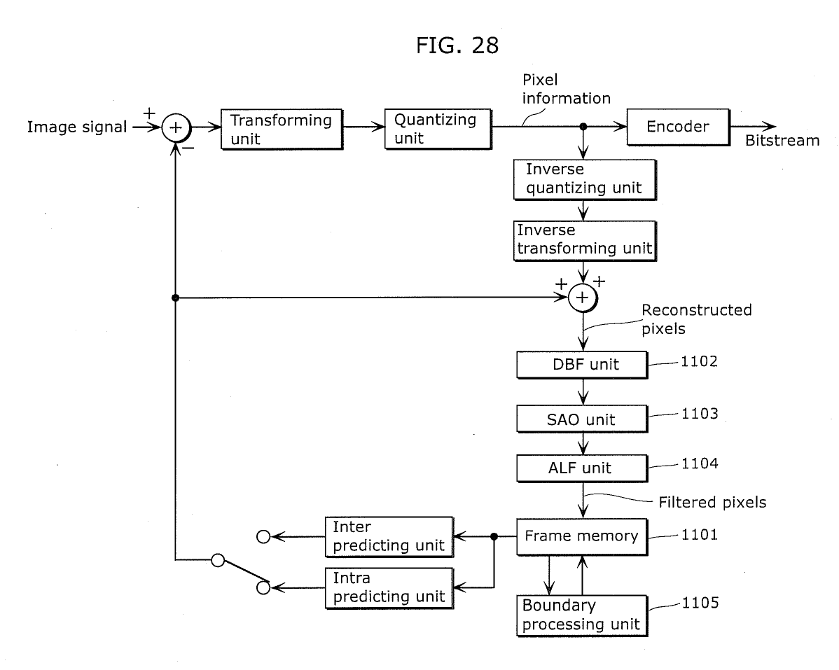

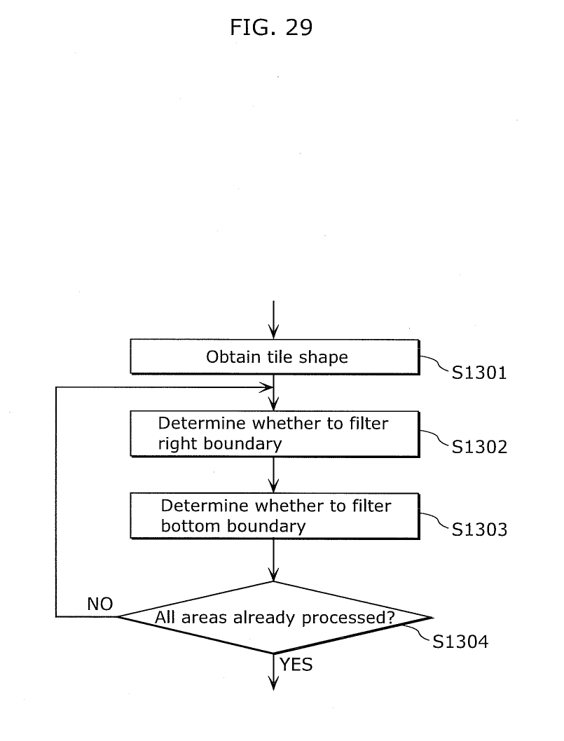

FIG. 28 is a block diagram showing an example of a coding apparatus according to Embodiment 4. An input target image signal is processed on a per coding unit basis. Prediction pixel values in each coding unit are calculated by either (i) an intra predicting unit in the case of intra coding with reference to pixels stored in a frame memory 1101, specifically, pixels of the picture including a target block or pixels of a picture not including the target block, or (ii) an inter predicting unit in the case of inter coding. The differences from the input signals are subjected to transform, quantization, and coding, resulting in a bitstream. In addition, the quantized coefficients are subjected to inverse quantization and inverse transform, and then are added to the difference values, resulting in reconstructed pixels. The reconstructed pixels are then subjected to filtering in a DBF unit 1102, an SAO unit 1103, and an ALF unit 1104, and are stored in a frame memory 1101. At this time, processing by the DBF, SAO, and ALF units are not always performed.

The DBF unit 1102 shown in FIG. 28 executes DBF processing defined in the “Deblocking filter process” in section 8.7 of Non-patent Literature 1 or in the “Deblocking filter process” in section 8.7.1 in the HEVC (Non-patent Literature 2). The DBF processing requires not only processing target pixels but also coding modes of blocks to which the pixels belong, motion vectors (MVs), presence or absence of coefficients in quantization, quantization parameters (QPs) etc. as information in filtering, and selects and applies one of filter strengths from three levels of Strong, Weak2pel, and Weak1pel. FIG. 26 shows a filter strength determination flow in DBF processing.

In addition, the SAO unit 1103 executes SAO processing defined in “Sample Adaptive Offset process” in section 8.7.2 in the HEVC (Non-patent Literature 2). In addition, the ALF unit 1104 executes ALF processing defined in the “Adaptive Loop Filter process” in section 8.7.2. The SAO processing does not require information such as coding modes etc. of blocks to which target pixels belong, but requires, as information in filtering, SAO offset information about the positions of the target pixels and the pixels adjacent to the target pixels. Here, it is a boundary processing unit 1105 that performs boundary processing on the image signal including boundary distortion to be stored in the frame memory.

The boundary processing unit 1105 performs operations in the same manner as the boundary processing unit 1205 in the decoding apparatus according to Embodiment 2, and thus no descriptions thereof is repeated.

Here, a description is given of an example case where an input image in FIG. 19 is received, and operations of applying a filter to only a boundary b303 are performed.

Tile shape information determined using a predetermined scheme is obtained (S1301). Next, a determination is made as to whether or not to apply a filter to a boundary (b301 in FIG. 19) between a current tile and the tile adjacent to the right side of the current tile (S1302). The boundary divides videos at different locations in FIG. 19, and thus is not subjected to any filtering. Accordingly, the value in [ ] of loop_filter_v_across_tiles_enabled_flag [0] is set to 0. A determination is made as to whether or not to filter the boundary (b302 in FIG. 19) with the tile adjacent at the bottom side (S1303). The boundary divides videos at different locations in FIG. 19, and thus is not subjected to any filtering. Accordingly, the value in [ ] of loop_filter_h_across_tiles_enabled_flag [0] is set to 0. Although this processing is terminated if all the areas are already processed (YES in S1304), all the areas are not yet processed (NO in S1304), and thus the processing continues for a next tile information. The boundary in the vertical direction of the next tile is a picture boundary (i==num_tile_columns_minus1 in FIG. 27A), and thus no information is transmitted. For this reason, no filter is applied to the bottom boundary. Continuously, both the areas divided by the tile boundary at the right end present the same input video, a filter is applied thereto, and thus 1 is set to the flag. Next, as for j==num_tile_rows_minus1, no information is transmitted. In this way, it is possible to determine whether or not to switch filters appropriately. Here, the flags determined here are entropy coded by the encoder shown in FIG. 28, and are recorded in the bitstream.

This makes it possible to switch filters depending on videos, and thereby to suppress decrease in the image quality and to increase the image quality.

### Embodiment 5

In a conventional general image compression, prediction values obtained from pixel information in a current picture and pixel information in a coded picture and difference values from coding target pixel values are subjected to frequency transform and quantization in coding, and the resulting coefficient values and supplemental information are binarized, that is, coded to generate a bitstream. At this time, the coded pictures are temporality decoded for reference from a picture etc. to be coded later. In decoding, the coefficient values and supplemental information are decoded from the bitstream, the prediction values obtained from the pixel information in the current picture and the pixel information in the coded picture are added to the coefficient values already subjected to inverse quantization and inverse frequency transform to generate a decoded image.

In the coding and decoding, each picture is divided into a plurality of blocks and is processed on a block-by-block basis. Here, coding performed with reference to pixel information of already coded or decoded pixels in a current picture is referred to as intra coding, and coding performed with reference to pixels in a previously coded or decoded picture is referred to as inter coding.

Images obtained through temporal decoding (hereinafter referred to as local decoding) in coding and images obtained through decoding are made up of reconstructed pixels obtained using difference values and are already subjected to filtering for reducing decrease in the image quality in coding. The HEVC standard in Non-patent Literature 2 includes, as filters or filtering, a deblocking filter (hereinafter referred to as DBF) intended to reduce block noise, adaptive pixel distortion removal (Sample Adaptive Offset, hereinafter referred to as SAO) intended to reduce quantization distortion compared to the original image, and an adaptive loop filter (Adaptive Loop Filter, hereinafter referred to as ALF).

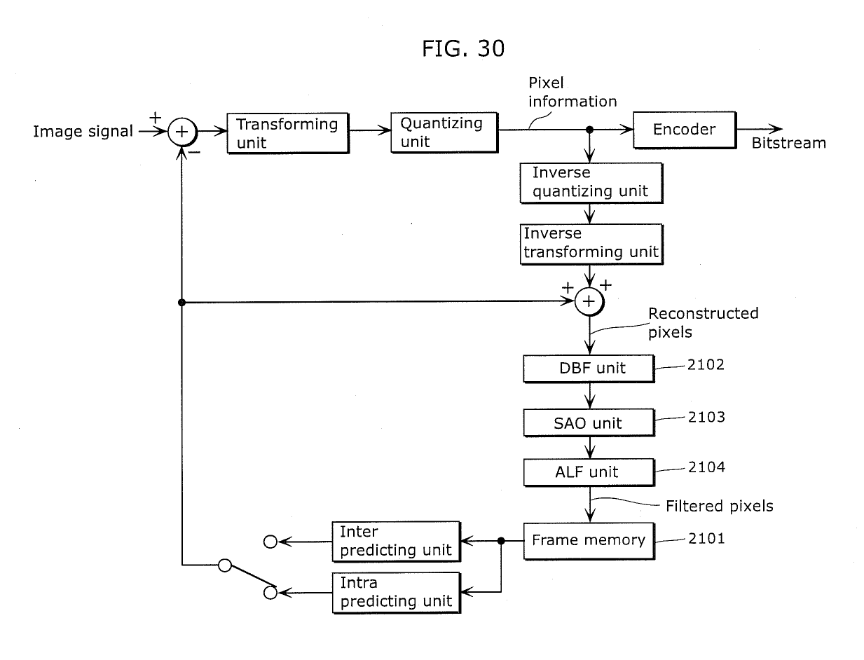

FIG. 30 is a block diagram showing a structure of a conventional coding apparatus. An input target image signal is processed on a per coding unit basis. Prediction pixel values in each coding unit are calculated by either (i) an intra predicting unit in the case of intra coding with reference to pixels stored in a frame memory 2101, specifically, pixels of the picture including a target block or pixels of a picture not including the target block, or (ii) an inter predicting unit in the case of inter coding. The differences from the input signals are subjected to transform, quantization, and coding, resulting in a bitstream. In addition, the quantized coefficients are subjected to inverse quantization and inverse transform, and then added to the difference values, resulting in reconstructed pixels. The reconstructed pixels are then subjected to filtering in a DBF unit 2102, an SAO unit 2103, and an ALF unit 2104, and are stored in a frame memory 2101. At this time, processing by the DBF, SAO, and ALF units may not be performed.

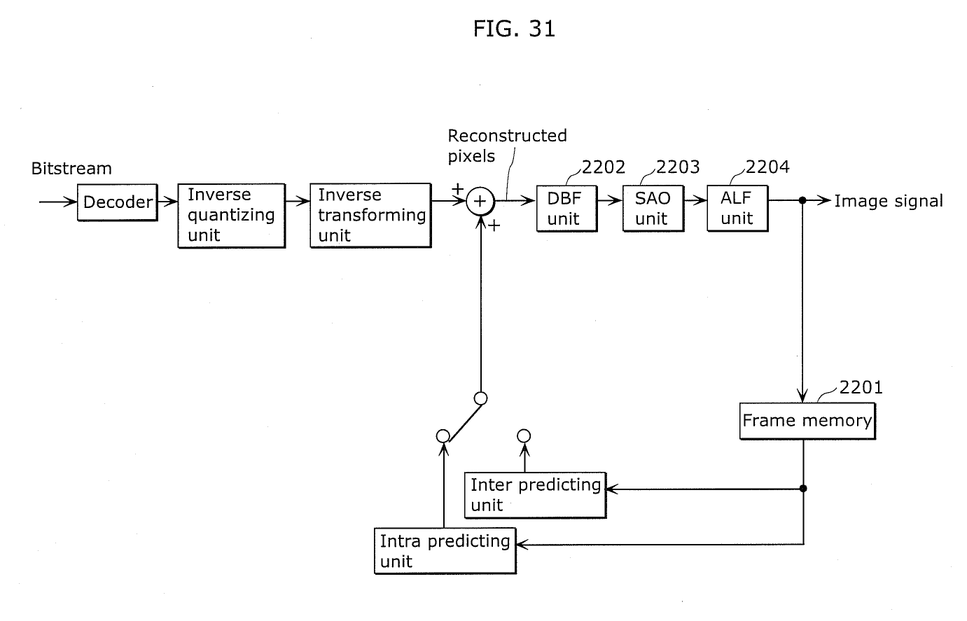

FIG. 31 is a block diagram showing a structure of a conventional decoding apparatus. An input bitstream is divided into processing units, and the processing units are subjected to decoding, inverse quantization, and inverse transform. Prediction pixel values in each processing unit are calculated by either (i) an intra predicting unit in the case of intra coding with reference to pixels stored in the frame memory 2201, specifically, pixels of the picture including a target block or pixels of a picture not including the target block, or (ii) an inter predicting unit in the case of inter coding. The prediction pixel values are added to difference values obtained through inverse transform, resulting in reconstructed pixels. These reconstructed pixels are filtered in the DBF unit 2202, the SAO unit 2203, and the ALF unit 2204, and then are stored in the frame memory 2201 and are output. At this time, processing by the DBF, SAO, and ALF units are not always performed.

Here, each of the DBF units 2102 and 2202 as shown in FIGS. 30 and 31 executes DBF processing defined in the “Deblocking filter process” in section 8.7 of Non-patent Literature 1 or in the “Deblocking filter process” in section 8.7.1 in the HEVC (Non-patent Literature 2). The DBF processing requires not only processing target pixels but also coding modes of blocks to which the pixels belong, motion vectors (MVs), presence or absence of coefficients in quantization, quantization parameters (QPs) etc. as information in filtering, and selects and applies one of filter strengths from three levels of Strong, Weak2pel, and Weak1pel. FIG. 26 shows a filter strength determination flow in DBF processing.

In addition, the SAO units 2103 and 2203 execute SAO processing defined in “Sample Adaptive Offset process” in section 8.7.2 in the HEVC (Non-patent Literature 2). In addition, the ALF units 1204 and 2204 execute ALF processing defined in the “Adaptive Loop Filter process” in section 8.7.2. The SAO processing does not require information such as coding modes etc. of blocks to which target pixels belong, but requires, as information in filtering, SAO offset information about the positions of the target pixels and the pixels adjacent to the target pixels.

In the conventional coding method (for example, in Non-patent Literature 1), a picture corresponding to a single image signal is divided into units called slices, and is coded on a slice-by-slice basis according to the order of raster scanning the blocks in the whole picture.

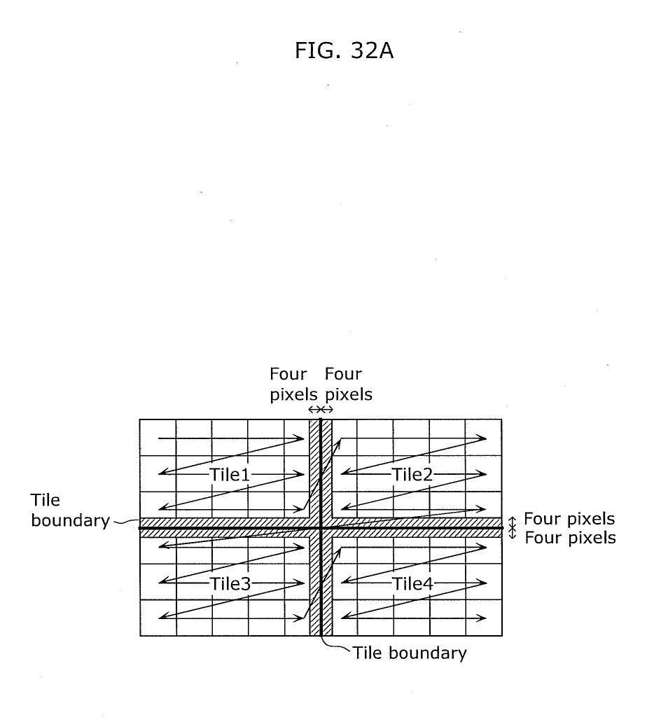

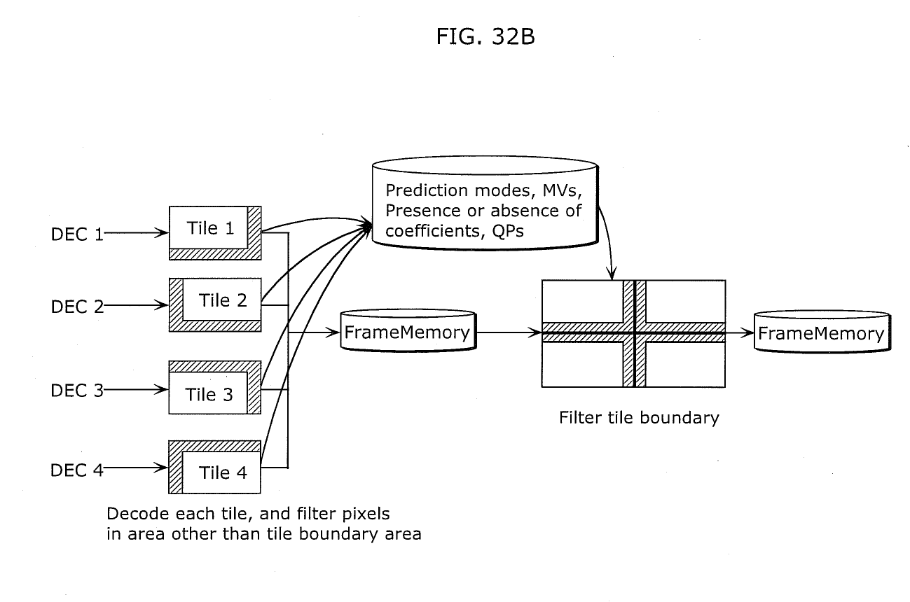

Furthermore, the HEVC (Non-patent Literature 2) introduces a tile format which makes it possible to divide a picture corresponding to a single image signal into tiles having a rectangular shape and to perform a raster scan within each of the tiles of the picture (see FIG. 32A). The tile format allows division of the picture in the vertical direction, and thus can provide advantageous effects of being able to reduce memory size requirements for pixel lines, and code or decode the tiles in parallel.

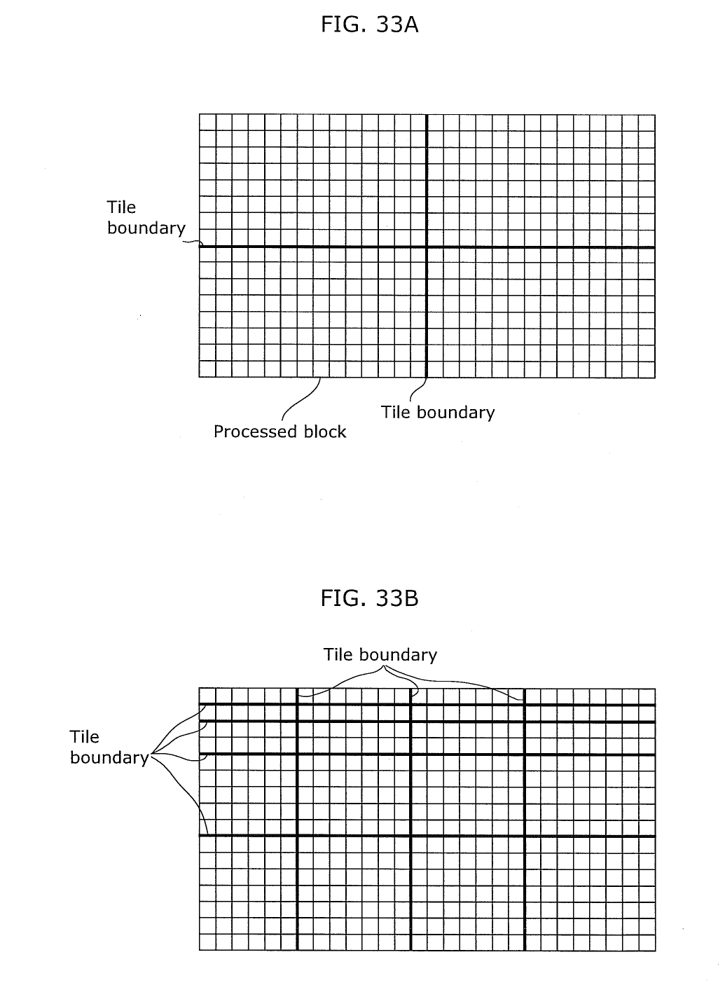

The HEVC makes it possible to divide, on a per block basis, a picture into tiles having various sizes (FIG. 33A and FIG. 33B).

However, in the aforementioned format, the boundary areas dividing the tiles are coded and decoded independently on a tile-by-tile basis, and thus the correlations between the pixels adjacent around the tile boundaries are lost, resulting in distortion. DBF, SAO, and ALF processing is performed in order to reduce such distortion. However, when the tiles are processed in parallel, such filtering on the pixels in the tiles are performed after the parallel processing on, for example, all the tiles in a picture are processed. In a system that requires a high processing speed such as real time processing, there is a need to increase the capability of processing the blocks in order to secure time for filtering the boundaries between target tiles in each picture. In addition, since filtering is performed on the tile boundaries later, there is a need to save information other than pixels and necessary for DBF and SAO processing. This increases the amount of information to be stored in a memory, and increases the band width (see FIG. 32B).

In addition, in order to apply a filter to each target boundary after the parallel processing on each tile is terminated, special control is required which is for skip normal filtering on the pixels adjacent to a tile boundary in the processing on the blocks in each tile.

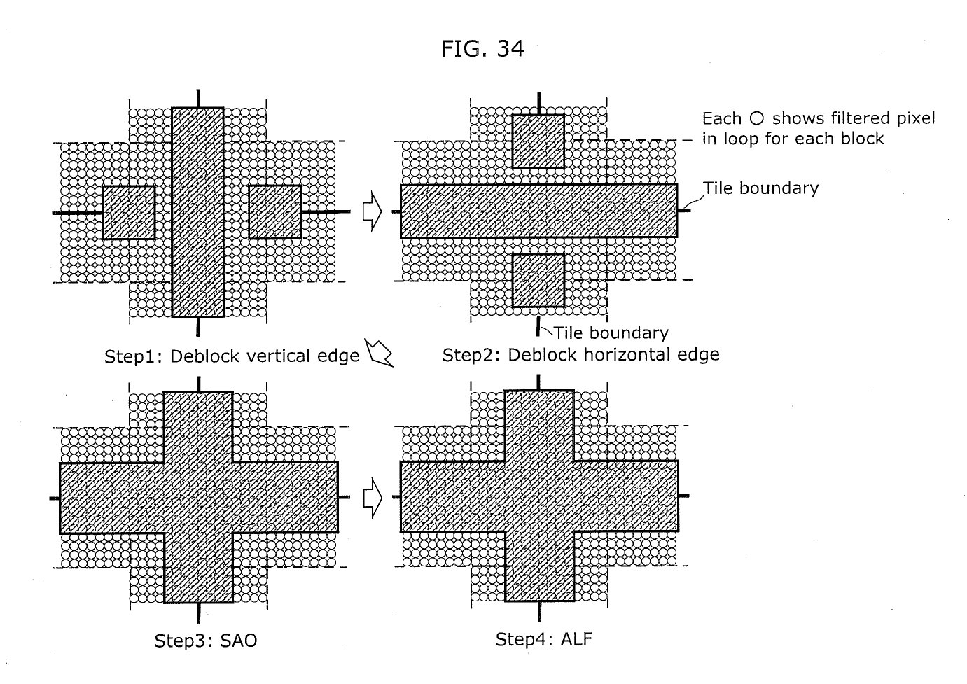

More detailed descriptions are given of with reference to FIGS. 32A, 32B, and 34. The four pixels adjacent at the hatched boundary areas in FIG. 32A are not subjected to filtering in the processing within each tile. Filtering is performed onto the tile boundaries in each picture according to the following listed order of Steps 1, 2, 3, and 4. Problems in this case are input and output band widths from a memory for the four pixels at both the sides of the boundaries to be processed, and the amount of related information and input and output band widths for the related information.

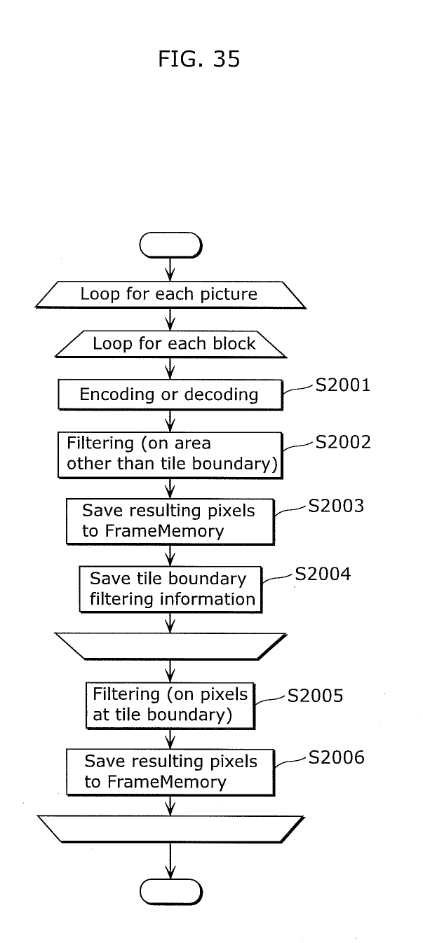

FIG. 35 shows an exemplary flow of coding processes. Steps S2001 to S2004 are processes for each block performed inside each of tiles. When the tiles are processed in parallel by processors or the like for the respective tiles as shown in FIG. 32B, these steps S2001 to S2004 are performed in parallel. Here, filtering in S2002 includes DBF, SAO, and ALF processing, and pixels other than pixels around tile boundaries mean the four pixels at both the sides of each boundary as described in each of FIG. 32A, FIG. 32B, and the like. Steps S2005 to S206 are executed on a picture-by-picture basis after Steps S2001 to S2004 on the blocks inside each tile are completed.

In view of this, Embodiment 5 is described. This embodiment has a flow obtained by modifying S2005 (filtering on tile boundaries performed on a picture-by-picture basis) in the processing flow shown in FIG. 35 and removing S2004 (saving of information for filtering tile boundaries).

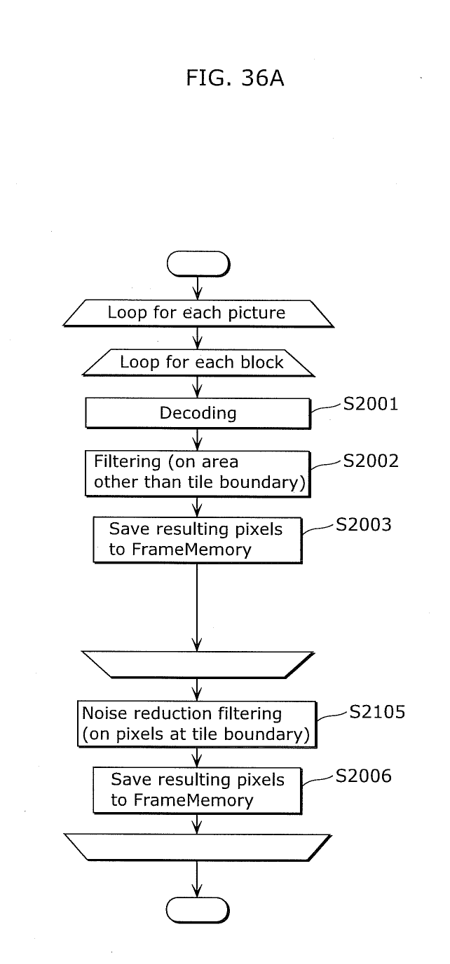

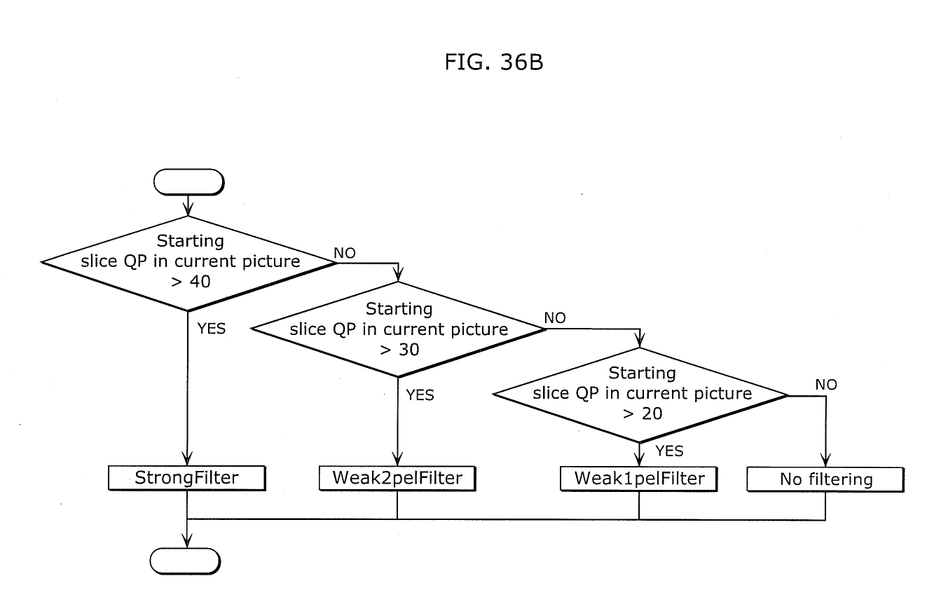

FIG. 36A shows a flow in Embodiment 5. In Step S2105, a simple noise removal filtering is applied instead of a conventional filtering on the adjacent pixels (four pixels at both the sides) of a tile boundary. The simple noise removal filtering may use, for example, one of the three kinds of strengths Strong, Weak2pel, and Weak1pel that are performed in a conventional DBF processing. The whole or a part of the SAO and ALF processing performed in the conventional S2005 may be skipped.

In addition, in S2105, noise removal filters to be applied may be switched depending on the quantization parameter of a starting slice in a picture. An example is shown in FIG. 36B. In this example, stronger filtering is applied with an increase in a QP value of the starting slice in the picture, and no filtering is performed when the QP value is smaller than a certain value. The value set here as a threshold value is an example. Furthermore, depending on the kind of or the condition for a noise removal filter to be selected based on a QP value, whether or not to select skipping of filtering is not fixed to the aforementioned manner.

According to the method in this embodiment, filtering is performed which is for reducing distortion without using any information other than pixels, such as coding modes and MVs necessary for DBF which is required conventionally in filtering on tile boundaries. This filtering reduces distortion, and at the same time, reduces the size of a memory area for saving such information other than pixels, and reduces the band width if the memory is an external memory.

### Embodiment 6

In view of this, Embodiment 6 is described. This embodiment has a flow obtained by modifying S2 (filtering on a block-by-block basis) and S5 (filtering on the tile boundaries performed on a picture-by-picture basis) in the processing flow shown in FIG. 35 and removing S4 (saving of information for filtering tile boundaries).

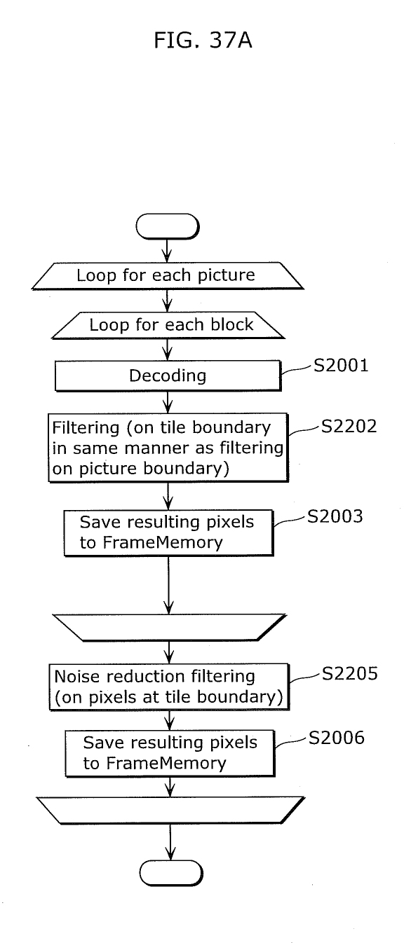

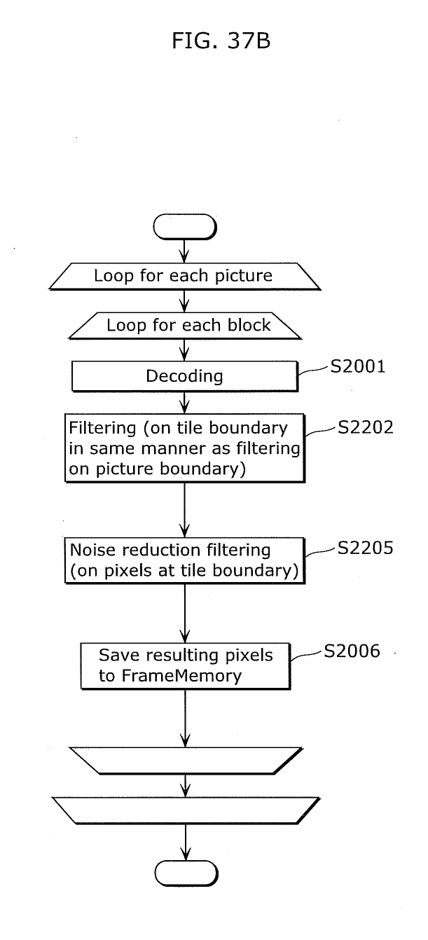

FIG. 37A shows a flow in Embodiment 6. In S2002, no filtering is performed on adjacent pixels (four pixels at both the sides) of a tile boundary, but in S2002 of FIG. 37A, and in S2202, filtering similar to the filtering on a picture boundary is performed on the adjacent pixels at a tile boundary. Furthermore, the process of S2205 is for performing simple noise reduction filtering without referring to information other than pixels in the same manner as in S2105 in FIG. 36A in Embodiment 5.

The method according to this embodiment eliminates any special condition such as skipping filtering in the case where a current boundary is a tile boundary when filtering each block in Embodiment 5, and thus can perform a conventional picture boundary processing. Accordingly, it is possible to reduce the number of processing steps and the circuit size. Furthermore, it is possible to increase the image quality of the pixels around the tile boundaries more significantly than in Embodiment 5 by performing S2205 after performing filter processing closer to the conventional filtering as much as possible onto the adjacent pixels around tile boundaries in a loop for each block (S2202).

Moreover, it is also possible to realize the method in this embodiment using a flow as shown in FIG. 37B. This flow is for performing, in the loop for each block, filtering on the adjacent pixels around the tile boundaries.

The processing of this flow is effective when a picture is divided into a plurality of small tiles and the tiles are sequentially processed instead of performing parallel processing.

In the case where no parallel processing is performed or the case where a picture is divided into small tiles and the tiles are sequentially processed, and when the tile boundaries are filtered for each picture instead of being filtered for each block of the tiles, the amount of processing increases (the amount of processing in FIG. 37A increases). Under such a condition, it is possible to suppress increase in the amount of processing to be performed for each picture by filtering the tile boundaries in the loop for each block using the flow as shown in FIG. 37B.

A structure obtained by combining the flows of FIG. 37A and FIG. 37B is also possible. For example, when a picture is made up of 20 tiles, and these tiles are processed in parallel in four processes, the boundaries of tiles included in one of the processes are filtered in a loop for each block, and the tile boundaries processed in another one of the processes are filtered in a loop for each picture.

### Embodiment 7

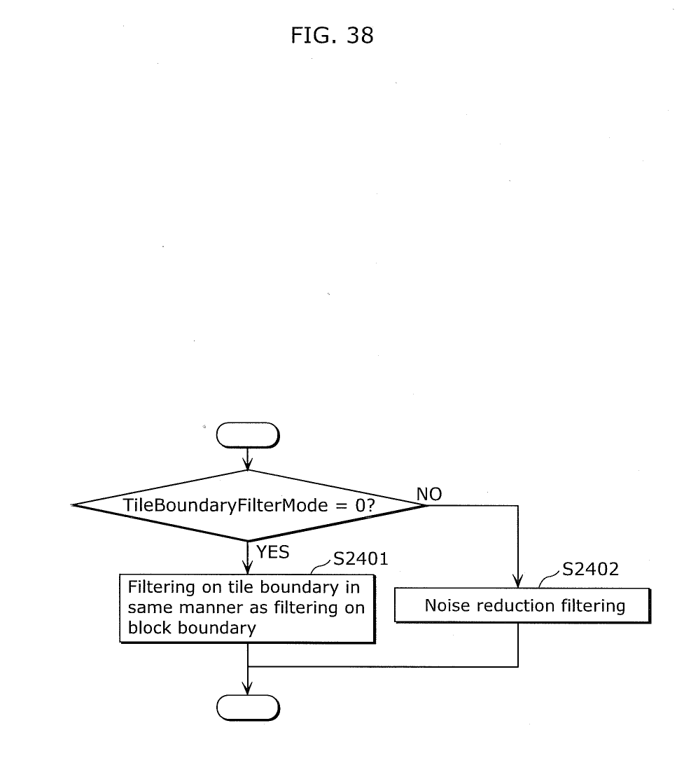

A description is given of FIG. 38 showing features of Embodiment 7.

This embodiment is intended to code modes (TileBoundaryFilterMode) each indicating which kind of filtering process is to be performed in filtering of tile boundaries and switch filtering processes by decoding the modes from a bitstream.

When TileBoundaryFilterMode=0 is satisfied, a current tile boundary is not differentiated and is subjected to filtering (DBF, SAO, ALF, and the like) similar to filtering performed on a normal block boundary (S2401). When TileBoundaryFilterMode=1 is satisfied, the pixels around a current tile boundary are subjected to noise reduction filtering as shown in Embodiments 5 and 6 (S2402).

Coded flags are used to switch filtering processes in this embodiment, but it is also good to automatically switch filtering processes depending on the number of tiles, the sizes of tiles in a picture, or the like.

This embodiment makes it possible to use a circuit having a conventional structure as long as, for example, a picture is divided into small tiles and these tiles are not processed in parallel.

Although only some exemplary embodiments have been described above, the scope of the Claims of the present application is not limited to these embodiments. Those skilled in the art will readily appreciate that various modifications may be made in these exemplary embodiments and that other embodiments may be obtained by arbitrarily combining the structural elements of the embodiments without materially departing from the novel teachings and advantages of the subject matter recited in the appended Claims. Accordingly, all such modifications and other embodiments are included in the present disclosure.

### Embodiment 8

The processing described in each of embodiments can be simply implemented in an independent computer system, by recording, in a recording medium, a program for implementing the configurations of the moving picture coding method (image coding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

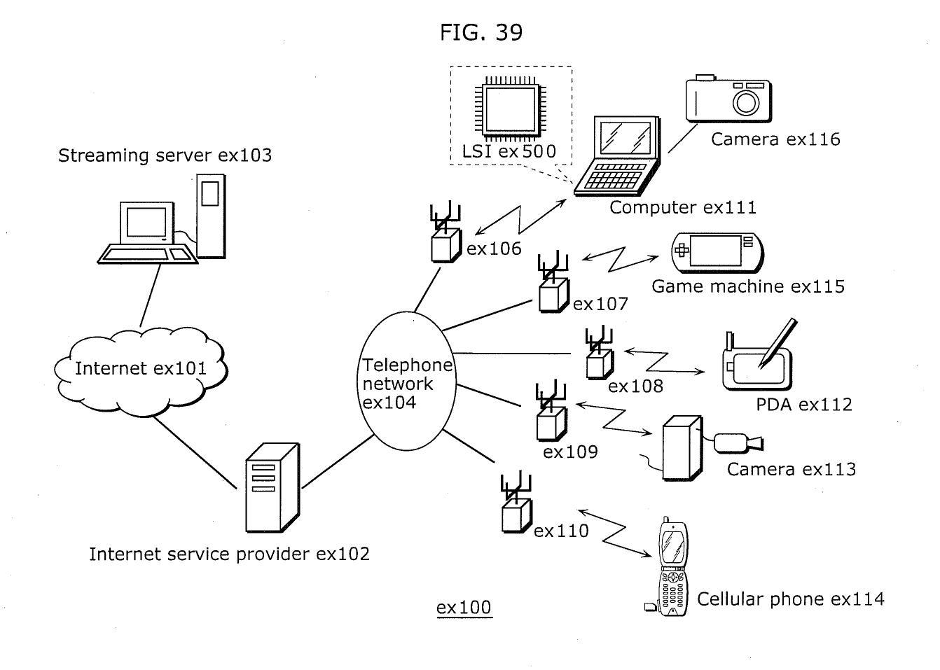

FIG. 39 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 39, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present disclosure), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present disclosure).

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

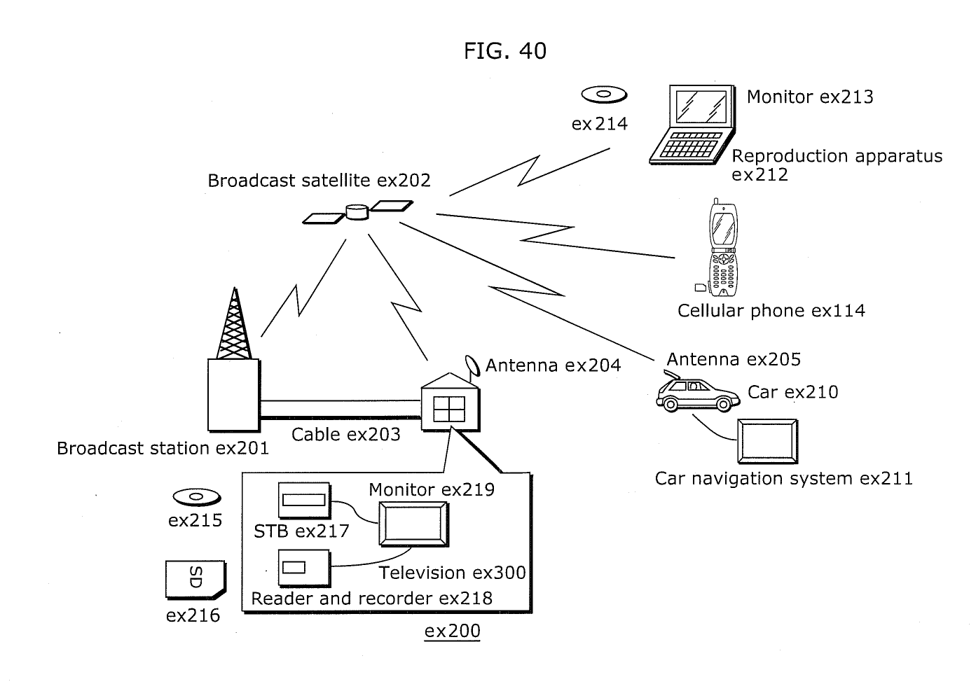

Aside from the example of the content providing system ex100, at least one of the moving picture coding apparatus (image coding apparatus) and the moving picture decoding apparatus (image decoding apparatus) described in each of embodiments may be implemented in a digital broadcasting system ex200 illustrated in FIG. 40. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present disclosure). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present disclosure).

Furthermore, a reader/recorder ex218 (i) reads and decodes the multiplexed data recorded on a recording medium ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

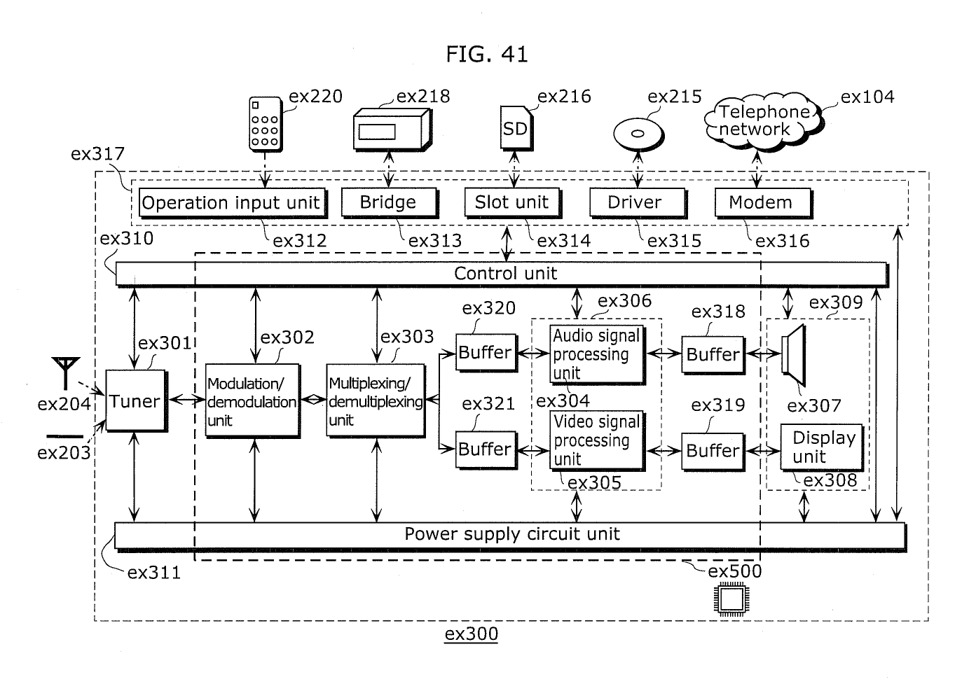

FIG. 41 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present disclosure); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

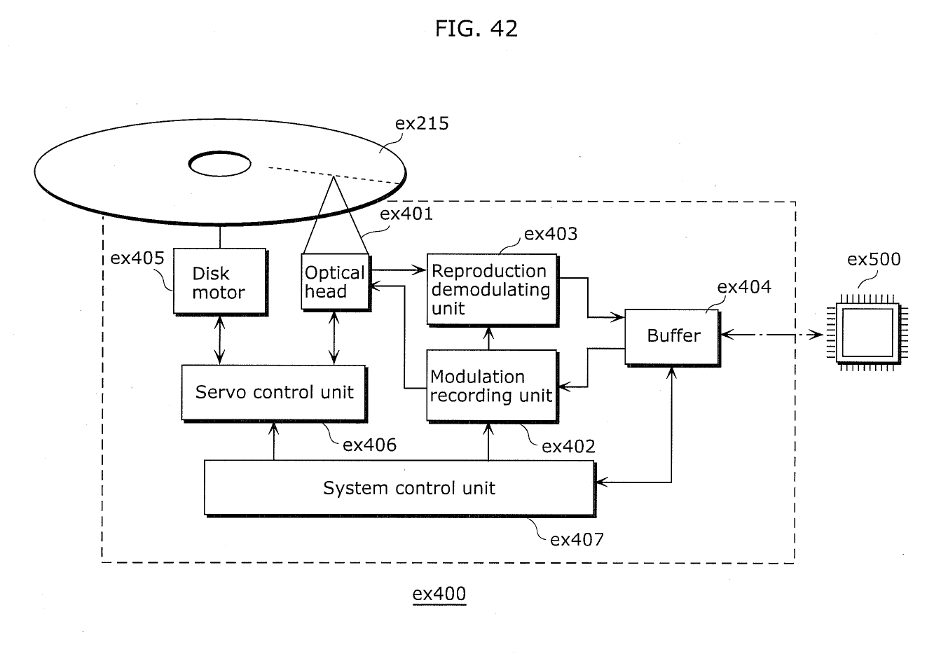

As an example, FIG. 42 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

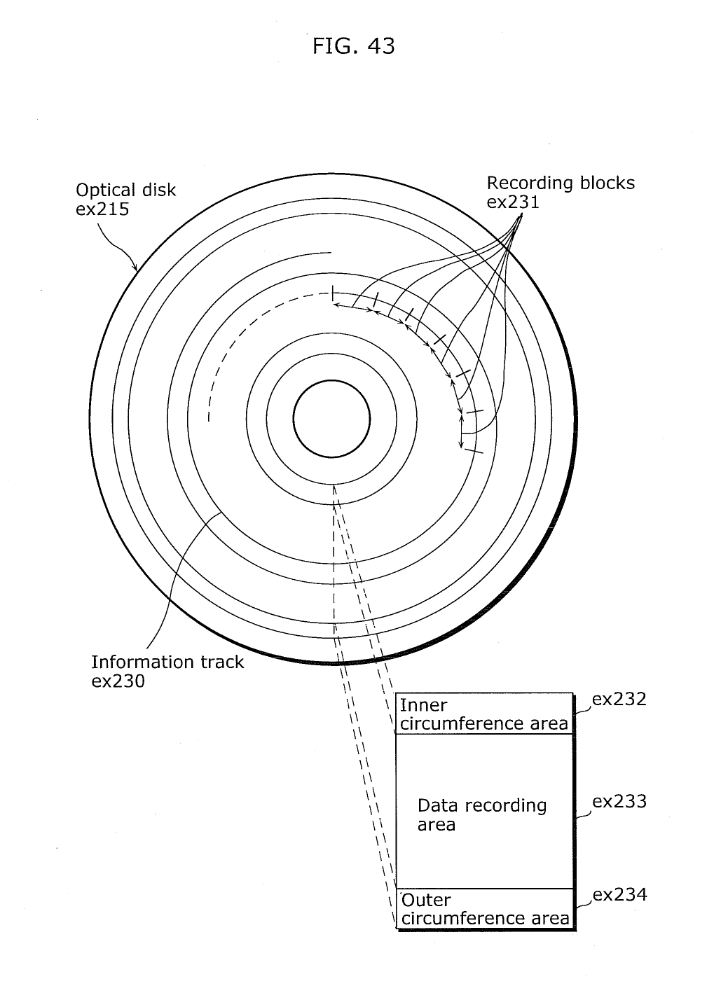

FIG. 43 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 41. The same will be true for the configuration of the computer ex111, the cellular phone ex114, and others.

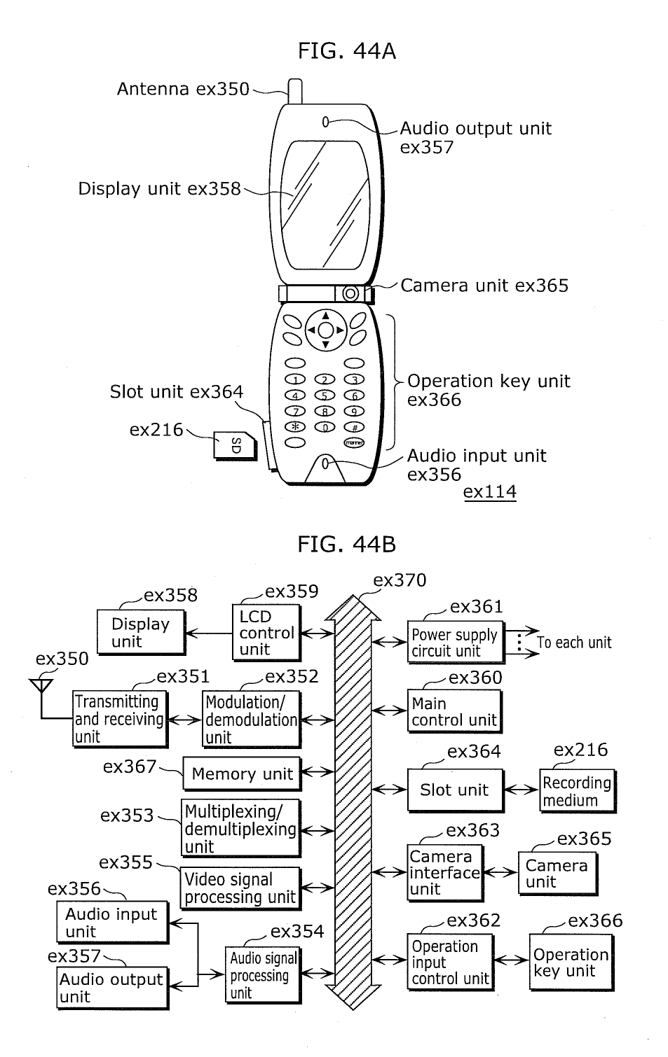

FIG. 44A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 44B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a, camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present disclosure), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present disclosure), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained.

Furthermore, the present disclosure is not limited to the above embodiments, and various kinds of modifications and revisions can be made without deviating the scope of the present disclosure.

### Embodiment 9

Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

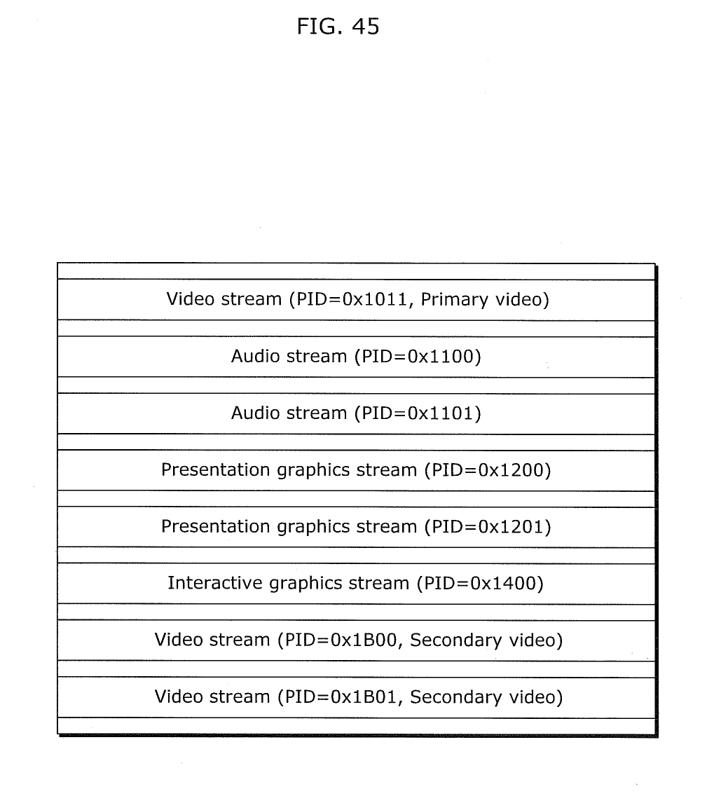

FIG. 45 illustrates a structure of the multiplexed data. As illustrated in FIG. 45, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

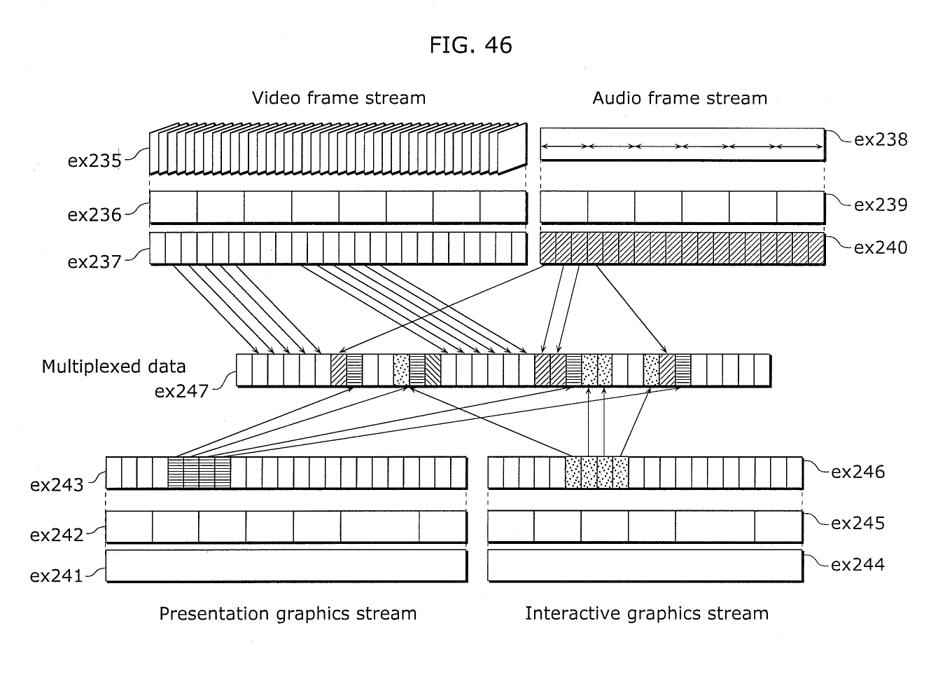

FIG. 46 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

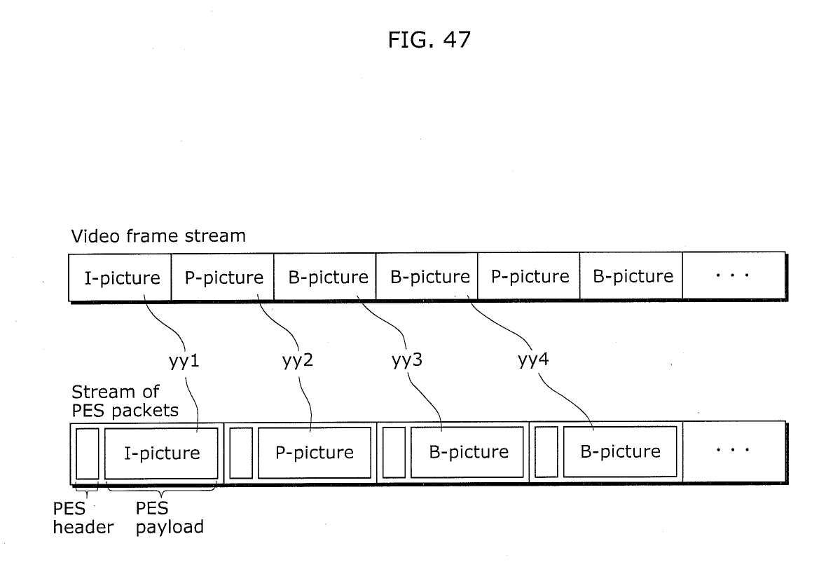

FIG. 47 illustrates how a video stream is stored in a stream of PES packets in more detail. The first bar in FIG. 47 shows a video frame stream in a video stream. The second bar shows the stream of PES packets. As indicated by arrows denoted as yy1, yy2, yy3, and yy4 in FIG. 47, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

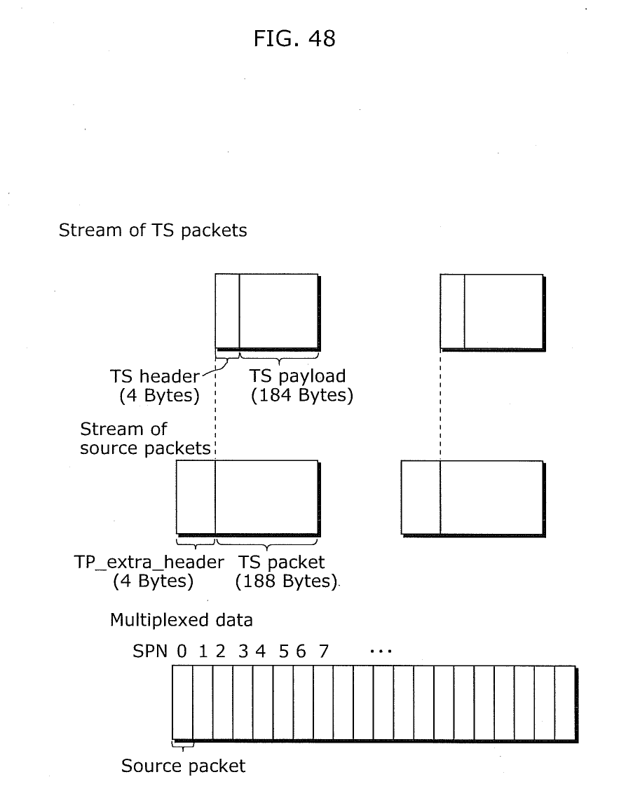

FIG. 48 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 48. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

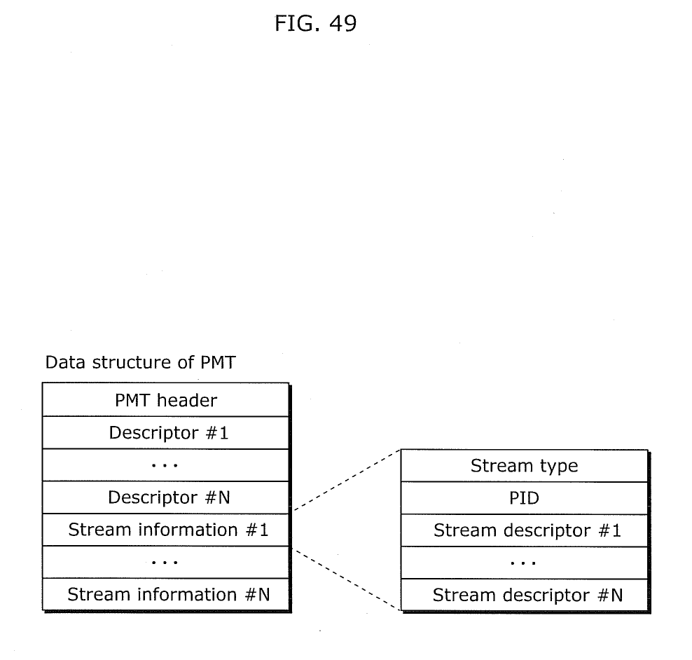

FIG. 49 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

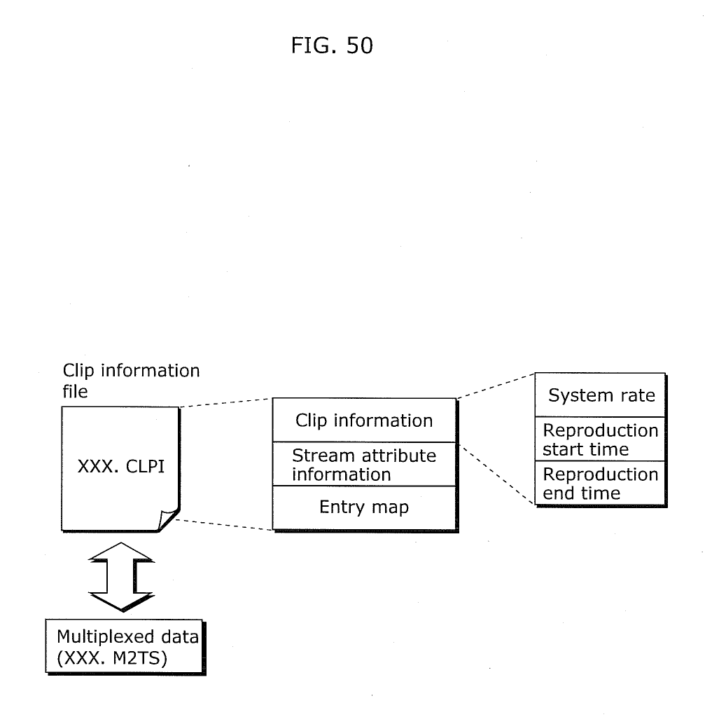

Each of the multiplexed data information files is management information of the multiplexed data as shown in FIG. 50. The multiplexed data information files are in one to one correspondence with the multiplexed data, and each of the files includes multiplexed data information, stream attribute information, and an entry map.

As illustrated in FIG. 50, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

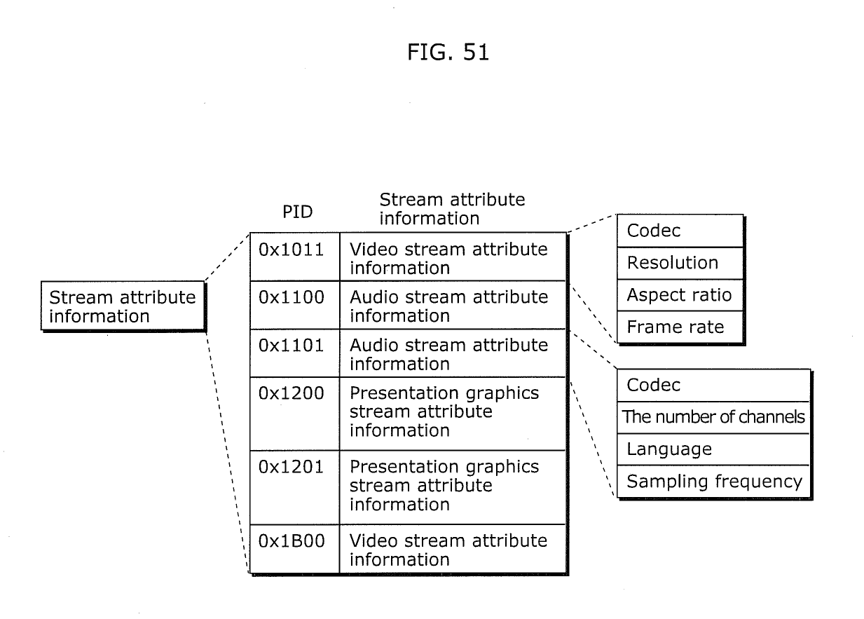

As shown in FIG. 51, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

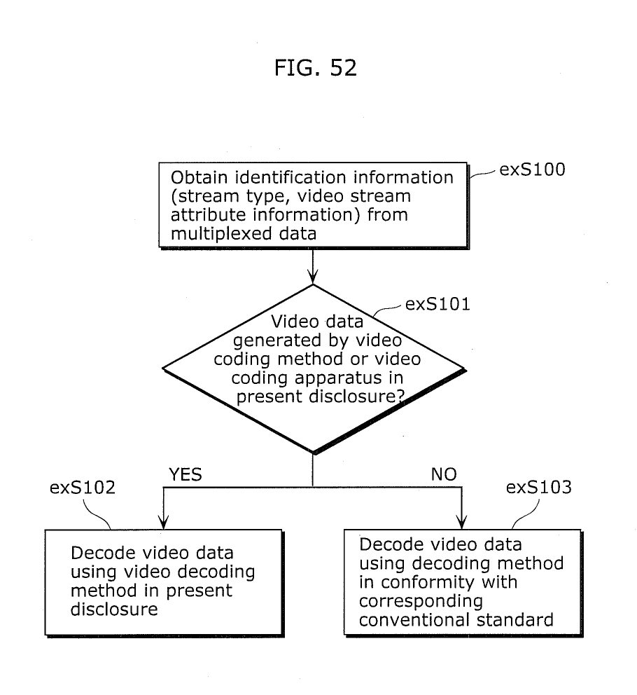

Furthermore, FIG. 52 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### Embodiment 10

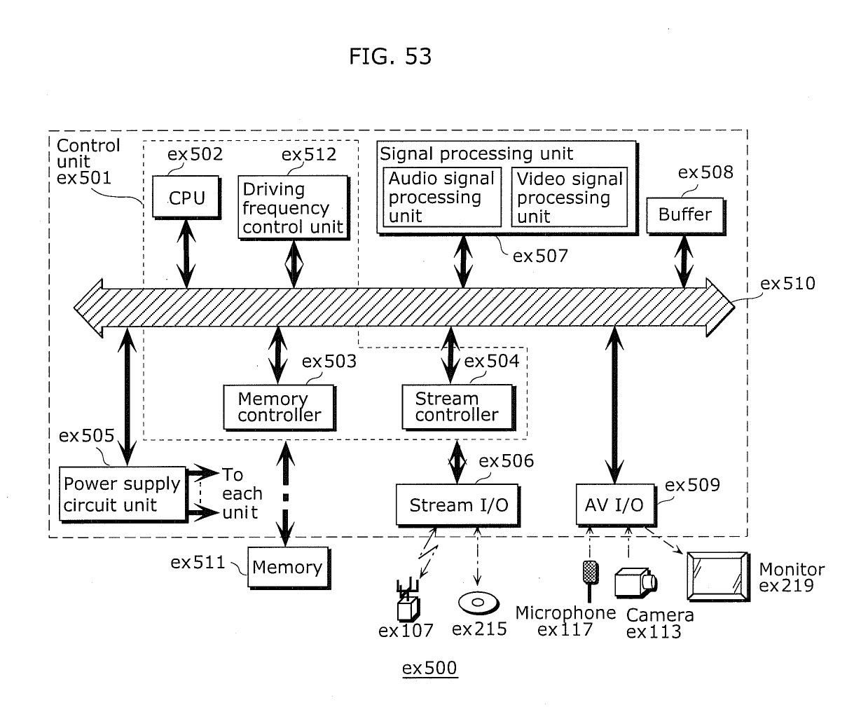

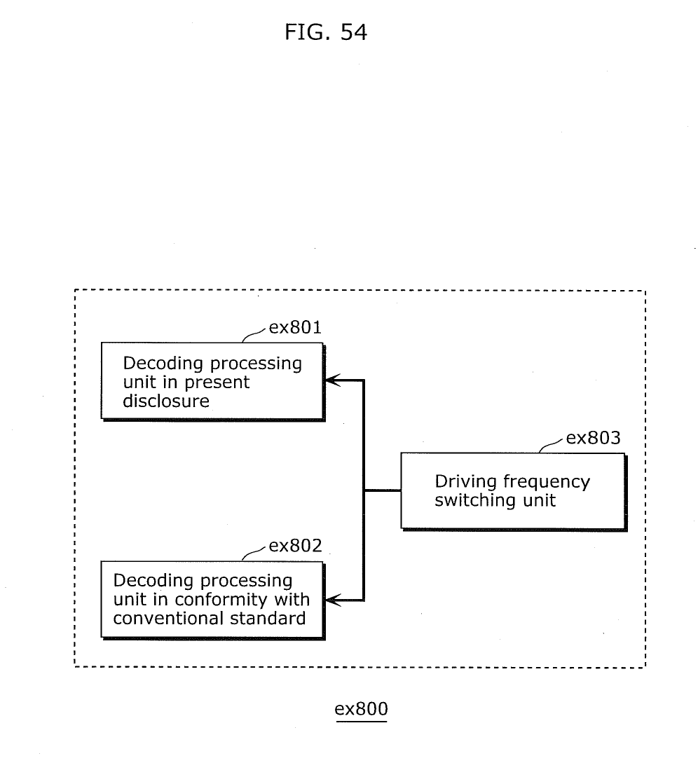

Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 53 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose. Such a programmable logic device can typically execute the moving picture coding method and/or the moving picture decoding method according to any of the above embodiments, by, loading or reading from a memory or the like one or more programs that are included in software or firmware.

In the future, with advancement in semiconductor technology, a brand-new technology may replace LSI. The functional blocks can be integrated using such a technology. The possibility is that the present disclosure is applied to biotechnology.

### Embodiment 11

When video data generated in the moving picture coding method or by the moving picture coding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

In order to solve the problem, the moving picture decoding apparatus, such as the television ex300 and the LSI ex500 is configured to determine to which standard the video data conforms, and switch between the driving frequencies according to the determined standard. FIG. 54 illustrates a configuration ex800 in the present embodiment. A driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

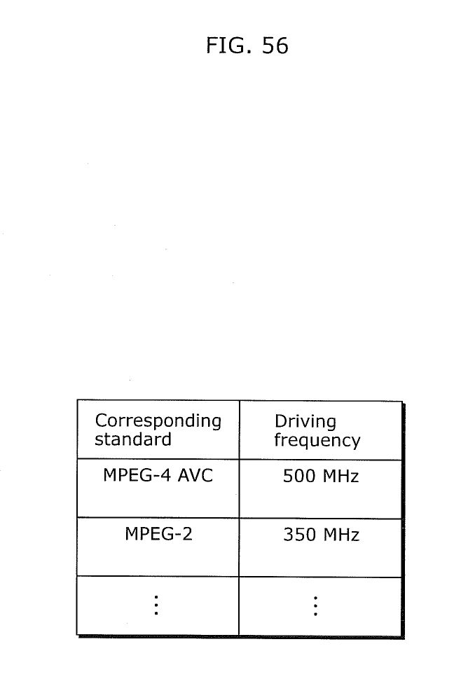

More specifically, the driving frequency switching unit ex803 includes the CPU ex502 and the driving frequency control unit ex512 in FIG. 53. Here, each of the decoding processing unit ex801 that executes the moving picture decoding method described in each of embodiments and the decoding processing unit ex802 that conforms to the conventional standard corresponds to the signal processing unit ex507 in FIG. 53. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 9 is probably used for identifying the video data. The identification information is not limited to the one described in Embodiment 9 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 56. The driving frequency can be selected by storing the look-up table in the buffer ex508 and in an internal memory of an LSI, and with reference to the look-up table by the CPU ex502.

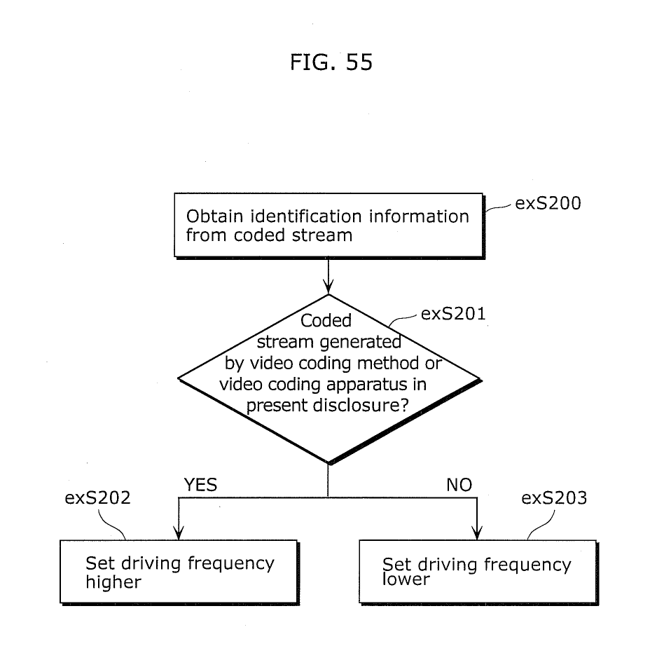

FIG. 55 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 12

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing unit ex507 that conform to the respective standards.

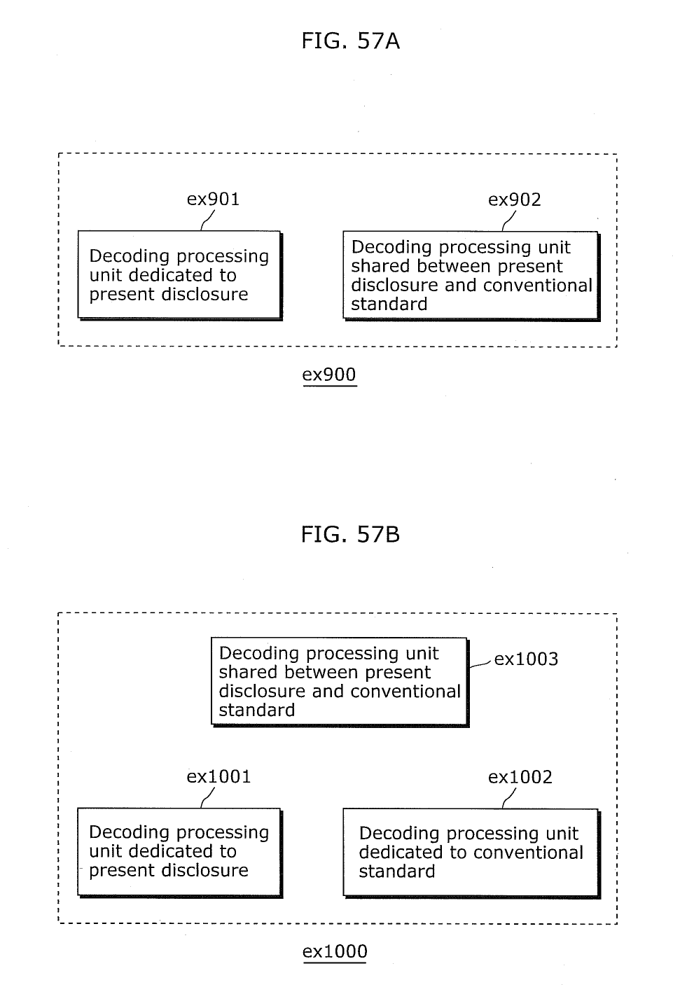

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 57A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing unique to an aspect of the present disclosure. Since the aspect of the present disclosure is characterized by a boundary filter in particular, for example, the dedicated decoding processing unit ex901 is used for the boundary filter. Otherwise, the decoding processing unit is probably shared for one of the entropy decoding, motion compensation, and inverse quantization, or all of the processing. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 57B shows another example in that processing is partly shared. This example uses a configuration including a dedicated decoding processing unit ex1001 that supports the processing unique to an aspect of the present disclosure, a dedicated decoding processing unit ex1002 that supports the processing unique to another conventional standard, and a decoding processing unit ex1003 that supports processing to be shared between the moving picture decoding method according to the aspect of the present disclosure and the conventional moving picture decoding method. Here, the dedicated decoding processing units ex1001 and ex1002 are not necessarily specialized for the processing according to the aspect of the present disclosure and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present disclosure and the moving picture decoding method in conformity with the conventional standard.

### INDUSTRIAL APPLICABILITY

The image coding apparatus and the image decoding apparatus according to aspects of the present disclosure are applicable to, for example, television receivers, digital video recorders, car navigation systems, mobile phones, digital cameras, digital video cameras, etc.

1. An image coding method of coding an image based on a processing unit to generate a bitstream, the method comprising:
filtering a boundary between processing units in a reconstructed image; and
storing the filtered reconstructed image in a first memory,
wherein, in the filtering, a first filtering process is performed on the boundary between the processing units when the boundary between the processing units is included in a boundary between parallel processing units, the first filtering process being different from a second filtering process which is performed when the boundary between the processing units is not included in the boundary between the parallel processing units.

2. The image coding method according to claim 1, further comprising:
determining whether or not a current processing unit has a boundary between parallel processing units; and
storing, in a second memory, pixel values which are (i) within the current processing unit and (ii) included in a predetermined range from the boundary between the parallel processing units when the current processing unit has the boundary between the parallel processing units, the current processing unit being reconstructed,
wherein, in the filtering, the first filtering process is performed using the pixel values stored in the second memory when the boundary between the processing units includes the boundary between the parallel processing units.

3. The image coding method according to claim 1, further comprising
determining a filter strength in the first filtering process, using a representative quantization parameter of at least one of two parallel processing units adjacent to the boundary between the parallel processing units when the boundary between the processing units is included in the boundary between the parallel processing units.

4. The image coding method according to claim 1, further comprising
adding, to the bitstream, a filter index indicating at least one kind of filtering process among predetermined kinds of filtering processes when the boundary between the processing units is included in the boundary between the parallel processing units,
wherein, in the filtering, the at least one kind of filtering process is performed as the first filtering process when the boundary between the processing units is included in the boundary between the parallel processing units.

5. The image coding method according to claim 1, further comprising:
determining whether or not a current processing unit has a boundary between parallel processing units; and
quantizing the current processing unit when the current processing unit has the boundary between the parallel processing units, using a quantization parameter smaller than a quantization parameter for use in the case where the current processing unit does not have a boundary between parallel processing units.

6. The image coding method according to claim 1,
wherein, in the filtering, a filtering process using only pixel value information is performed as the first filtering process, when the boundary between the processing units is included in the boundary between the parallel processing units.

7. The image coding method according to claim 1,
wherein, in the filtering, only a filtering process for reducing block noise is performed as the first filtering process, when the boundary between the processing units is included in the boundary between the parallel processing units.

8. The image coding method according to claim 1,
wherein, in the filtering, a filtering process which is the same in kind as a filtering process for a picture boundary and a filtering process using only pixel value information are performed as the first filtering process, when the boundary between the processing units is included in the boundary between the parallel processing units.

9. The image coding method according to claim 1,
wherein, in the filtering, the first filtering process and the second filtering process are selectively switched and performed on the boundary between the processing units when the boundary between the processing units is included in the boundary between the parallel processing units.

10. An image decoding method of decoding an image coded based on a processing unit and included in a bitstream, the method comprising:
filtering a boundary between processing units in a reconstructed image; and
storing the filtered reconstructed image in a first memory,
wherein, in the filtering, a first filtering process is performed on the boundary between the processing units when the boundary between the processing units is included in a boundary between parallel processing units, the first filtering process being different from a second filtering process which is performed when the boundary between the processing units is not included in a boundary between parallel processing units.

11. The image decoding method according to claim 10, further comprising:
determining whether or not a current processing unit has a boundary between parallel processing units; and
storing, in a second memory, pixel values which are (i) within the current processing unit and (ii) included in a predetermined range from the boundary between the parallel processing units when the current processing unit has the boundary between the parallel processing units, the current processing unit being reconstructed,
wherein, in the filtering, the first filtering process is performed using some of the pixel values stored in the second memory when the boundary between the processing units includes the boundary between the parallel processing units.

12. The image decoding method according to claim 10, further comprising
determining a filter strength in the first filtering process, using a representative quantization parameter of at least one of two parallel processing units adjacent to the boundary between the parallel processing units when the boundary between the processing units is included in the boundary between the parallel processing units.

13. The image decoding method according to claim 10, further comprising
parsing, from the bitstream, a filter index indicating at least one kind of filtering process among predetermined kinds of filtering processes,
wherein, in the filtering, the at least one kind of filtering process indicated by the filter index is performed as the first filtering process when the boundary between the processing units is included in the boundary between the parallel processing units.

14. The image decoding method according to claim 10, further comprising:
determining whether or not a current processing unit has a boundary between parallel processing units; and
performing, when the current processing unit has a boundary between parallel processing units, inverse quantization on the current processing unit, using a quantization parameter smaller than a quantization parameter for use in the case where the current processing unit does not have a boundary between parallel processing units.

15. The image decoding method according to claim 10,
wherein, in the filtering, a filtering process using only pixel value information is performed as the first filtering process, when the boundary between the processing units is included in the boundary between the parallel processing units.

16. The image decoding method according to claim 10,
wherein, in the filtering, only a filtering process for reducing block noise is performed as the first filtering process, when the boundary between the processing units is included in the boundary between the parallel processing units.

17. The image decoding method according to claim 10,
wherein, in the filtering, a filtering process which is the same in kind as a filtering process for a picture boundary and a filtering process using only pixel value information are performed as the first filtering process, when the boundary between the processing units is included in the boundary between the parallel processing units.

18. The image decoding method according to claim 10,
wherein, in the filtering, the first filtering process and the second filtering process are selectively switched and performed on the boundary between the processing units when the boundary between the processing units is included in the boundary between the parallel processing units.

19. A non-transitory computer-readable recording medium having a program recorded thereon for causing a computer to execute the image coding method according to claim 1.

20. A non-transitory computer-readable recording medium having a program recorded thereon for causing a computer to execute the image decoding method according to claim 10.
